(19) United States
(12) Patent Application Publication
(10) Pub. No.: US 2023/0385844 A1
(43) Pub. Date: Nov. 30, 2023

(54) GRANTING PROVISIONAL CREDIT BASED ON A LIKELIHOOD OF APPROVAL SCORE GENERATED FROM A DISPUTE-EVALUATOR MACHINE-LEARNING MODEL

(71) Applicant: Chime Financial, Inc., San Francisco, CA (US)

(72) Inventors: Anton Laptiev, Vancouver (CA); Jiby Babu, Leander, TX (US)

(21) Appl. No.: 17/664,776

(22) Filed: May 24, 2022

(51) Int. Cl. G06Q 20/40; G06N 5/02

(52) U.S. Cl. CPC G06Q 20/407; G06Q 20/4016; G06N 5/025

(57) ABSTRACT

The present disclosure relates to systems, non-transitory computer-readable media, and methods for generating, utilizing a dispute-evaluator machine-learning model, a likelihood of approval score for a submitted dispute request and granting or denying provisional credit for the dispute request based on the likelihood of approval score. In particular, in one or more embodiments, the disclosed system receives a dispute request with information associated with disputed transactions within the dispute request. Based on the generated likelihood of approval score satisfying a predetermined threshold, the disclosed system can grant or deny to the user account a provisional credit.

### BACKGROUND

As online transactions have increased in recent years, network-transaction-security systems have increasingly used computational models to detect and protect against cyber fraud, cyber theft, or other network security threats that compromise encrypted or otherwise sensitive information. As a result of an increase in risks to existing network-transaction-security systems, recent years have seen significant improvements in utilizing computing devices to dispute network transactions. In some cases, existing network-transaction-security systems use heuristic computing models to automatically process dispute requests claiming that transfer of assets, funds, or another transaction was fraudulent, unauthorized, or otherwise illegitimate. For example, conventional network-transaction-security systems can utilize heuristic computing models that identify and approve dispute requests below a certain transaction amount and/or identify and deny fraudulent dispute requests based on certain transaction factors.

For instance, current network-transaction-security systems can follow heuristics that label a dispute request as below a preset transaction amount and automatically grant approval of the dispute request. In these instances, current network-transaction-security systems attempt to conserve resources by not investigating dispute requests below certain transaction amounts. Furthermore, in an attempt to increase network security, current systems utilize preestablished heuristic policies for ferreting out dispute requests that do not match their criteria. For example, current systems determine whether dispute requests are fraudulent or real based in part on heuristic rules, such as denying dispute requests from certain merchants, approving dispute requests for certain transaction amounts, and approving or denying dispute requests based on the date of the transaction. If a dispute request satisfies the preestablished policies, then the current system receives the dispute requests in a queue for further processing by an agent.

Although current network-transaction-security systems utilize heuristic models to resolve some dispute requests, current systems suffer from a number of issues in relation to efficiency and accuracy. For example, by attempting to conserve resources via automatically granting dispute requests below certain transaction amounts, current systems inevitably allow some fraudulent dispute requests that had no chance of approval to be approved. By utilizing preestablished and rigid heuristics, current systems inadvertently exclude legitimate dispute requests that do not match the preestablished heuristic framework as well as include bad dispute requests (e.g., claims with a low likelihood of approval and fraudulent claims). Additionally, in current systems, dispute requests moved to a queue for further processing often leads to an increase in user accounts contacting current systems to check the status of their dispute request. This exacerbates additional inefficiencies by allocating computing resources to address user account inquiries regarding the status of their dispute requests.

Moreover, as alluded to above, current network-transaction-security systems attempt to rectify potentially fraudulent dispute requests by determining when a threshold number of risk factors are present, such as identifying a particular transaction type or a particular transaction amount. But the computational models of existing network-transaction-security systems have proven inefficient/inaccurate and often misidentify false negative dispute requests that are indeed legitimate dispute requests or false positive dispute requests that are not in fact legitimate dispute requests.

Under some heuristic computing models, for instance, an existing network-transaction-security system only identifies a dispute request that fraudulently asserts an unauthorized transaction has occurred after a series of fraudulent dispute requests have been submitted by a digital account or linked digital account. But using a serial dispute record as a heuristic routinely results in a series of cyber fraud. Such an inflexible computing model often can detect a fraudulent dispute request only after failing to detect other fraudulent dispute requests or similar events. These, along with additional problems and issues, exist with regard to conventional network-transaction-security systems.

### BRIEF SUMMARY

This disclosure describes embodiments of systems, non-transitory computer-readable media, and methods that solve one or more of the foregoing or other problems in the art or provide other benefits. In particular, the disclosed systems generate, utilizing a dispute-evaluator machine-learning model, a likelihood of approval score for a submitted dispute request and grant or deny provisional credit for the dispute request based on the likelihood of approval score. For example, the disclosed system receives from a client device a dispute request that disputes an authorization or authenticity of one or more transactions and generates a likelihood of approval score for the dispute request using a dispute-evaluator machine-learning model. The dispute-evaluator machine-learning model uses information associated with the disputed transactions in the dispute request to generate the likelihood of approval score. Based on the likelihood of approval score meeting a predetermined threshold, the disclosed system grants or denies to a user account a provisional credit corresponding to the dispute request. Additionally, the disclosed system can grant or deny the provisional credit in real time and utilize a variety of different models to generate the likelihood of approval score.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a block diagram of an environment for implementing a provisional credit determination system in accordance with one or more embodiments.

FIG. 2 illustrates a block diagram of a provisional credit determination system utilizing a dispute-evaluator machine-learning model to generate a likelihood of approval score for a dispute request and granting or denying provisional credit to a user account in accordance with one or more embodiments.

FIG. 3 illustrates a block diagram of a provisional credit determination system utilizing different models to generate scores in accordance with one or more embodiments.

FIG. 4 illustrates a block diagram of a provisional credit determination system processing a dispute request and revising a provisional credit status in accordance with one or more embodiments.

FIG. 5 illustrates a block diagram of a provisional credit determination system utilizing a dispute-evaluator machine-learning model to generate a likelihood of approval score for a dispute request and granting final credit in accordance with one or more embodiments.

FIG. 6 illustrates a block diagram of a provisional credit determination system utilizing a model to generate a user account quality score in accordance with one or more embodiments.

FIG. 7 illustrates a block diagram of a provisional credit determination system determining whether provisional credit is available for a user account in accordance with one or more embodiments.

FIG. 8A-8C illustrates example graphical user interfaces of a computing device granting or withdrawing provisional credit from a user account in accordance with one or more embodiments.

FIG. 9 illustrates a block diagram of the provisional credit determination system utilizing and training a dispute-evaluator machine learning model to generate likelihood of approval scores for dispute requests in accordance with one or more embodiments.

FIG. 10 illustrates a graph depicting an importance of various features for a dispute-evaluator machine-learning model in accordance with one or more embodiments.

FIGS. 11A-11B illustrates graphs depicting true-positive rates, false-positive rates, and precision/recall of the provisional credit determination system utilizing a dispute-evaluator machine learning model to determine likelihood of approval scores for dispute request in accordance with one or more embodiments.

FIG. 12 illustrates an example series of acts for utilizing a dispute-evaluator machine-learning model to generate a likelihood of approval score for a dispute request and granting provisional credit based on the likelihood of approval score in accordance with one or more embodiments.

FIG. 13 illustrates a block diagram of a computing device for implementing one or more embodiments of the present disclosure.

FIG. 14 illustrates an example environment for a provisional credit determination system in accordance with one or more embodiments.

### DETAILED DESCRIPTION

This disclosure describes one or more embodiments of a provisional credit determination system that receives a dispute request, generates a likelihood of approval score by using a dispute-evaluator machine-learning model, and if the likelihood of approval score meets a predetermined threshold, granting a provisional credit to a user account corresponding to the dispute request. To elaborate, the provisional credit determination system uses a dispute-evaluator machine-learning model to generate the likelihood of approval score which predicts the likelihood of a dispute request being approved. The dispute-evaluator machine-learning model uses many different features associated with disputed transactions of a dispute request to generate the likelihood of approval score. The issuance of provisional credit to a user account corresponds with the amount disputed and approved by the provisional credit determination system. After an agent computing device receives the dispute request and actually processes the request, the provisional credit determination system can convert the provisional credit to final credit or reverse the provisional credit based on an approval or denial indication from the agent computing device. Moreover, the provisional credit determination system can use a variety of machine learning models and/or rule-based models to decide in real time whether to grant provisional credit.

As indicated above, the provisional credit determination system can identify features of a dispute request disputing a network transaction by determining features of a dispute request from among various feature groups. Such identified or detected features can come from groups of features for a transaction associated with the dispute request (e.g., a peer-to-peer transaction or a merchant purchase), an account associated with the dispute request, or a computing device, among other feature groups. Feature groups can include related individual features, such as a zip code feature, a merchant category code feature, an account dormancy time feature, a sign-in feature, or a transaction-number feature.

Based on the identified or detected features, the provisional credit determination system can then utilize a dispute-evaluator machine-learning model in determining the likelihood of approval score. The dispute-evaluator machine-learning model is trained on features for previous dispute requests with labels identifying the claims as previously being approved, rejected, or being fraudulent. As explained further below, the dispute-evaluator machine-learning model can take various forms, including, for example, a gradient boosted decision tree (e.g., XG boost) or a neural network.

Also discussed above, the provisional credit determination system can utilize a variety of models to determine whether to grant provisional credit to a user account. For example, the provisional credit determination system can utilize a fraud prediction machine learning model to determine the likelihood of fraud by the user making the dispute (as opposed to the likelihood of dispute approval machine learning model), or a rule-based model that applies certain features of the user account with the dispute request to decide whether to grant provisional credit. In particular, the provisional credit determination system can use these models singly or in combination with one another to make a provisional credit determination.

Further, the provisional credit determination system can grant provisional credit to a user account in real time or near real time. For example, in response to receiving a dispute request, the provisional credit determination system can generate the likelihood of approval score in real time and make an automatic determination whether to grant provisional credit to the user account. In particular, within seconds of making the determination to grant provisional credit, the user account associated with the dispute request receives credit corresponding to the disputed amount.

As discussed, the provisional credit determination system can utilize a rule-based model. For example, one iteration of the rule-based model can include generating a user account quality score. Essentially, the rule-based model extracts features from the user account associated with the dispute request to determine the quality of the account. In particular, this can include identifying the loan-to-value ratio (LTV) of the user account. Based on the determined user account quality score, the provisional credit determination system can set a provisional credit limit.

As also discussed, the provisional credit determination system can utilize a variety of models. For example, the provisional credit determination system can incorporate historical data from the user account's previous dispute request into the models to generate the likelihood of approval score. In particular, the provisional credit determination system monitors historical data such as past dispute requests filed by the user account and the results of those past dispute requests to influence subsequent likelihood of approval scores.

The provisional credit determination system also utilizes other aspects to influence the likelihood of approval score. For example, these other aspects include information associated with disputed transaction(s), such as feature groups. In particular, the provisional credit determination system uses a plurality of feature groups, such as user data or merchant data, and weighs each of the plurality of feature groups differently to influence the likelihood of approval score generated by the dispute-evaluator machine-learning model or one or more of the other discussed models.

Furthermore, the provisional credit determination system can decide whether provisional credit is available based on a variety of factors. For example, some of these factors include determining the age of the account or the dormant status of the account. In particular, other features may include determining the merchant of the dispute request and comparing that to a list of predetermined merchants or determining the dispute request amount and comparing that to a predetermined amount threshold.

As mentioned above, the provisional credit determination system can alter the status of the provisional credit on a user account. For example, if the agent computing device processing a dispute request determines the request as fraudulent, the provisional credit determination system can reverse the provisional credit originally granted to the user account based on an approval indication from the agent computing device. On the other hand, if the agent computing device processes the request and determines the request as legitimate, the provisional credit determination system converts the provisional credit to final credit on the user account based on a denial indication from the agent computing device.

Moreover, the provisional credit determination system can automatically grant final credit instead of provisional credit. For example, if the provisional credit determination system determines that the generated score exceeds a final credit threshold, then the provisional credit determination system grants final credit. Or, in other example embodiments, if the provisional credit determination system considers the transaction amount minimal, then the provisional credit determination system can also grant final credit. In particular, the provisional credit determination system can set the final credit threshold higher (for approving dispute requests) than the provisional credit predetermined threshold.

The provisional credit determination system provides several technical advantages over existing network-transaction-security systems. For example, by generating the likelihood of approval score using a dispute-evaluator machine-learning model, the provisional credit determination system effectively identifies dispute requests that either likely exhibit features of a fraudulent dispute request or likely exhibit features of a legitimate dispute requests—by intelligently determining whether a dispute request is likely to be approved. In doing so, the provisional credit determination system increases overall internal cybersecurity by further ferreting out bad actors from defrauding servers and other computing systems and by identifying legitimate requests upfront (prior to timely processing done by agent computing devices). This in turn improves the overall efficiency of the provisional credit determination system.

Additionally, the provisional credit determination system improves on computing efficiency by identifying dispute requests with a high likelihood of approval and consequently issuing provisional credit to an associated user account. Accordingly, issuing provisional credit to an associated user account intelligently reduces volume of computing devices contacting the provisional credit determination system or sending follow up messages regarding their dispute request claims. Furthermore, issuing provisional credit also ferrets out fraudulent requests because dispute requests with a low likelihood of approval often are more likely to be associated with bad actors.

In addition to improving on computing efficiency, by generating the likelihood of approval score using a dispute-evaluator machine-learning model and granting to a user account provisional credit based on that score, the provisional credit determination system improves the real-time accuracy and real-time efficiency with which network-transaction-security systems approve or deny dispute requests. For example, rather than automatically granting certain dispute requests below a transaction amount due to a lack of resources (as in conventional systems), the provisional credit determination system can use the dispute-evaluator machine-learning model to decide whether the dispute request has a high likelihood of approval. The dispute-evaluator model provides an additional resource for the provisional credit determination system to improve efficient use of computational resources by increasing the likelihood that the provisional credit determination system can make a reliable decision for approving dispute requests.

Unlike conventional systems which inefficiently occupy computational resources with a backlog of dispute request claims, the provisional credit determination system efficiently grants to the user account a provisional credit based on the likelihood of approval score. Specifically, in response to the provisional credit determination system determining that the likelihood of approval score satisfies a predetermined threshold, the provisional credit determination system automatically grants a provisional credit to the user account. This results in minimizing latencies associated with transferring funds between client devices and transferring funds between a client device and the provisional credit determination system.

As indicated by the foregoing discussion, the present disclosure utilizes a variety of terms to describe features and advantages of the provisional credit determination system. For example, as used herein, the term “dispute request” refers to a digital claim or complaint submitted by an account that disputes or otherwise indicates an issue with one or more network transactions. For instance, a dispute request can include a claim disputing an authenticity, authorization, control, or other legitimacy of one or more network transactions. For example, the dispute request could claim that a network transaction was not authorized (e.g., that an account-take-over event occurred). The dispute request can include data corresponding with a disputed transaction, for example, a merchant (and merchant information) associated with the disputed transaction, an amount of the disputed transaction, status of the disputed transaction (e.g., pending or settled), an indication of a dispute classification, the date and/or time of the disputed transaction, transaction identification numbers or codes, as well as any other metadata associated with the disputed transaction.

As mentioned above, dispute requests include disputed transactions. For example, As used herein, the term “transaction” refers to a transaction performed as part of an exchange of tokens, currency, or data between accounts or other connections of a computing system. In some embodiments, the transaction can be a peer-to-peer transaction that transfers currency, non-fungible tokens, digital credentials, or other digital content between accounts. In some embodiments, the transaction may be a transaction with a merchant (e.g., a purchase transaction).

Relatedly, as used herein, the term “disputed transaction” refers to a user-identified transaction that the client device associated with the user adds to a dispute request. In particular, the client device can provide for display via a graphical user interface, to a user, a list of recent transactions. To illustrate, using the client device, a user can select a transaction from the list and generate a dispute request for the selected transaction. The dispute request can include any number of disputed transactions. Moreover, a disputed transaction corresponds to a single transaction on the user account.

As also mentioned, the provisional credit determination system generates a likelihood of approval score. As used herein, the term “likelihood of approval score” refers to a metric indicating a likelihood of a dispute request being approved or disapproved. In particular, in some cases, a likelihood of approval score comprises a value indicating a likelihood that a dispute request is approved or disapproved because the dispute request corresponds to features indicating the dispute request is inauthentic, unauthorized, outside of the account holder's control, or otherwise lacks legitimacy. To illustrate, the provisional credit determination system can determine a likelihood of approval score for a particular dispute request as 0.80, which indicates an 80% chance of approval, or a likelihood of approval score for a different dispute request as 0.30, which indicates an 30% chance of approval.

As mentioned above, the provisional credit determination system utilizes a predetermined threshold. For example, as used herein the term “predetermined threshold” refers to a threshold score that (if satisfied) indicates that a dispute request is likely to be approved. To illustrate, the predetermined threshold can include a 0.85 score where the provisional credit determination system 102 deems all likelihood of approval scores exceeding the 0.85 score as satisfying the threshold. A predetermined threshold can be set at various other score levels, such as a 0.55 score or a 0.75 score, etc.

As mentioned above, the provisional credit determination system grants provisional credit. For example, as used herein, the term “provisional credit” refers to a temporary placeholder credit within the user account that corresponds with a transaction amount. In particular, a provisional credit can include a temporary or preliminary credit to a user account that corresponds to an amount of a dispute request. To illustrate, the user may dispute a gas station transaction for $35.00 and after the provisional credit determination system determines the dispute request as satisfying a predetermined threshold, the provisional credit determination system grants a provisional credit of $35.00 to the user account corresponding to the dispute. By contrast, in some cases, a provisional credit can include a temporary or preliminary credit to a user account that represents a portion of an amount in a dispute request, such a half of an amount in dispute.

As also mentioned above, the provisional credit determination in some instances can grant final credit. For example, as used herein, the term “final credit” refers to an actualized, non-temporary credit on the user account. In particular, a final credit includes a credit on the user account that is finalized and is not considered provisional credit. To illustrate, the provisional credit determination system can grant a user account a $35.00 provisional credit, and in response to the provisional credit determination system deciding the dispute request corresponding to the provisional credit as approved, the provisional credit determination system converts the provisional credit of $35.00 into a final credit of $35.00.

As mentioned above, the provisional credit determination system can make determinations in real time. For example, as used herein, the term “real time” refers to 1-60 seconds within an event. For example, real time includes 1-60 seconds within filing or receiving a dispute request. In particular, the provisional credit determination system receives a dispute request and can generate the likelihood of approval score and decide whether to grant provisional credit within 1-60 seconds of receiving the dispute request. As noted below, in some embodiments, the provisional credit determination system receives a dispute request and can generate the likelihood of approval score and decide whether to grant provisional credit in near-real time of receiving the dispute request, such as within several minutes (e.g., 4-5 minutes).

As also used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

In some cases, the machine-learning model comprises a fraud detection machine-learning model. As used herein, the term “dispute-evaluator machine-learning model” refers to a machine-learning model trained or used to determine whether dispute requests disputing network transactions are likely or unlikely to be approved. In some cases, the dispute-evaluator machine-learning model refers to a trained machine-learning model that generates a likelihood of approval score or likelihood of approval classification for a dispute request disputing an authenticity, authorization, control, or other legitimacy of one or more network transactions. For example, the dispute-evaluator machine-learning model can utilize a series of gradient boosted decision trees (e.g., XGBoost algorithm), while in other cases, the dispute-evaluator machine-learning model is a random forest model, a multilayer perceptron, a linear regression, a support vector machine, a deep tabular learning architecture, a deep learning transformer (e.g., self-attention-based-tabular transformer), or a logistic regression.

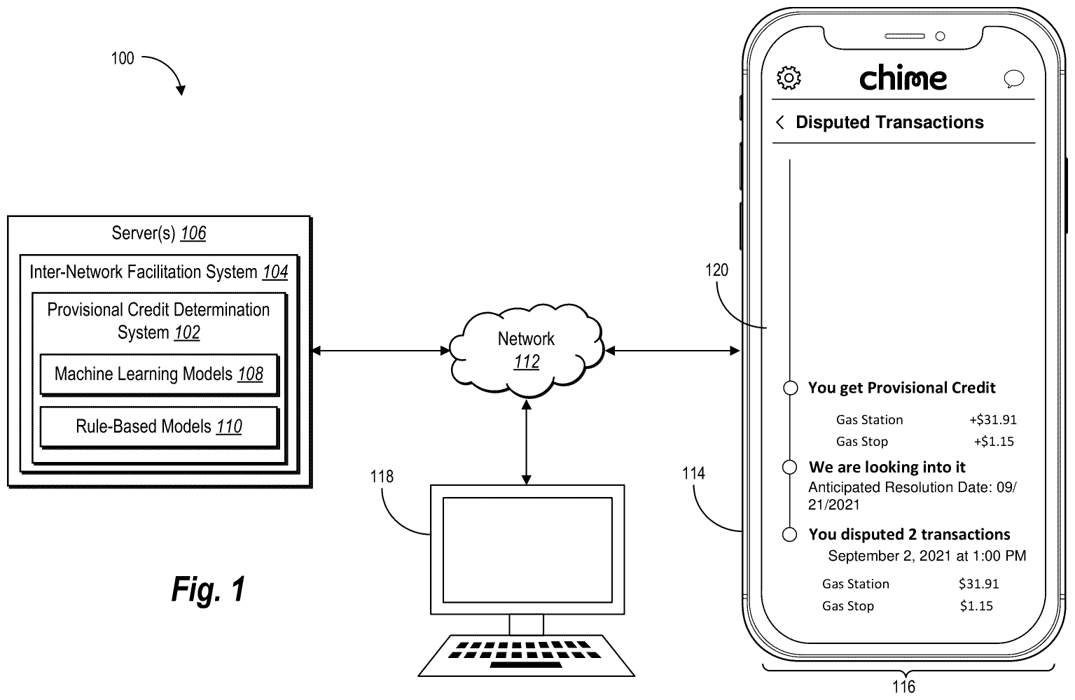

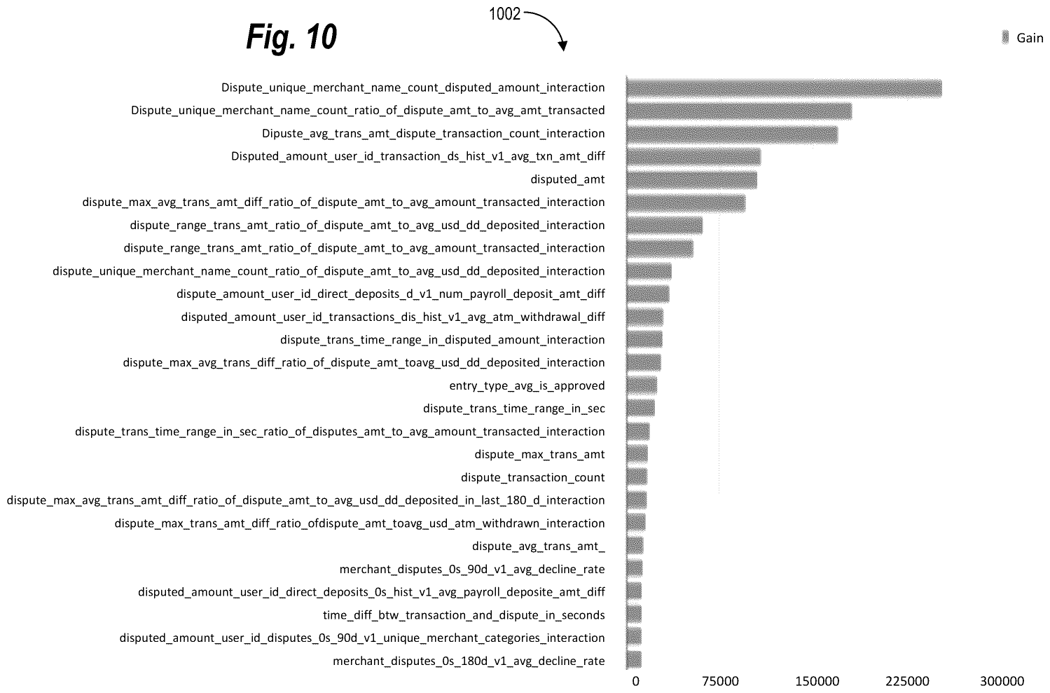

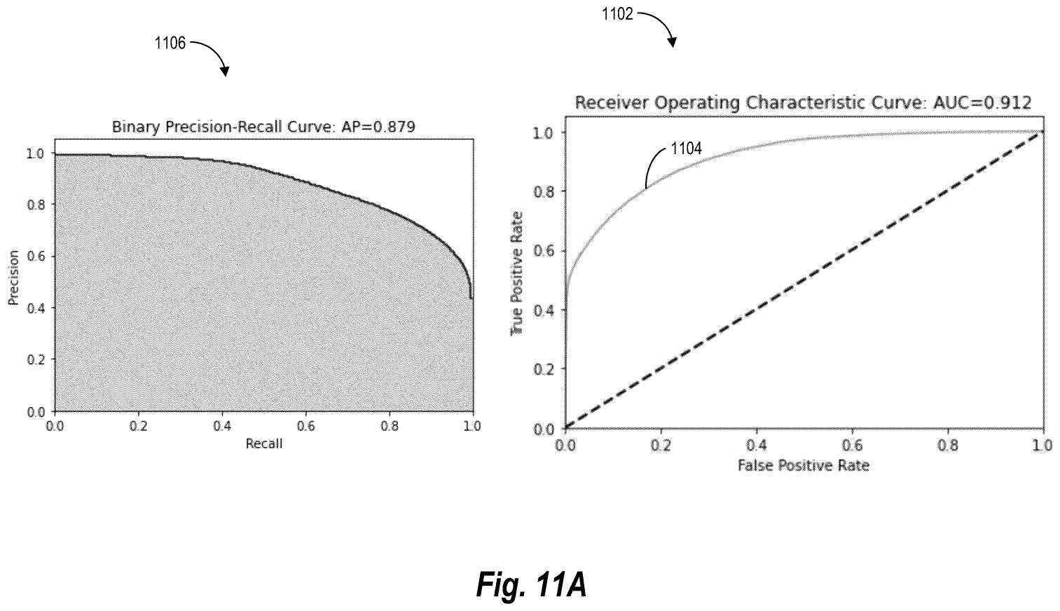

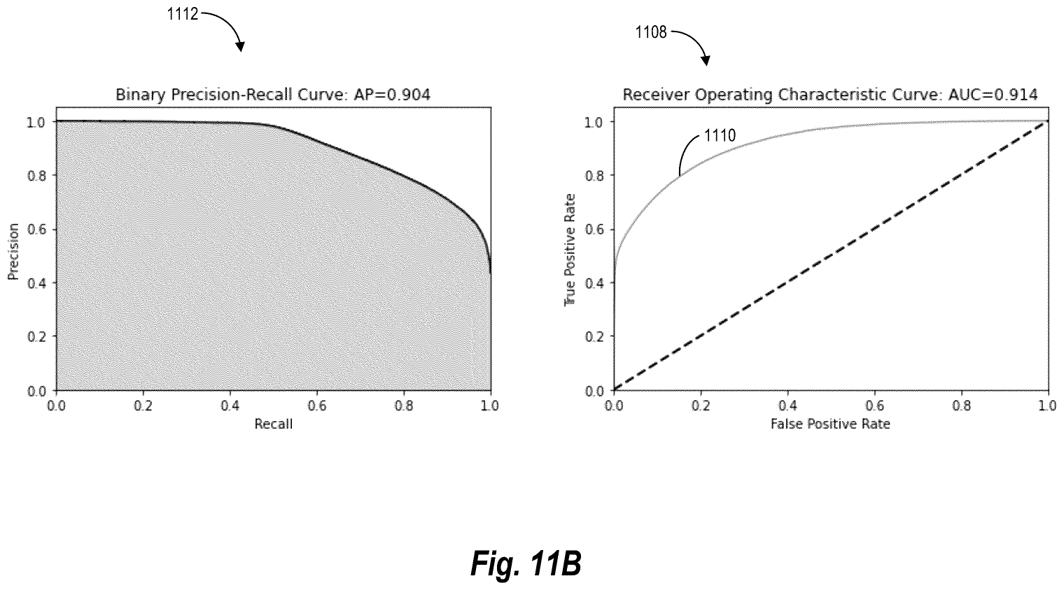

Additional detail regarding the provisional credit determination system will now be provided with reference to the figures. In particular, FIG. 1 illustrates a block diagram of a system environment 100 for implementing a provisional credit determination system 102 in accordance with one or more embodiments. As shown in FIG. 1, the system environment 100 includes server(s) 106 implementing the provisional credit determination system 102 as part of an inter-network facilitation system 104. The provisional credit determination system 102 also includes machine learning models 108 and rule-based models 110. The environment of FIG. 1 further includes a client device 114, a device application 116, and an agent computing device 118. The server(s) 106 can include one or more computing devices to implement the provisional credit determination system 102. Additional description regarding the illustrated computing devices (e.g., the server(s) 106, and the client device 114) is provided with respect to FIGS. 10-11 below.

As shown, the provisional credit determination system 102 utilizes the network 112 to communicate with the client device 114 and the agent computing device 118. The network 112 may comprise a network as described in relation to FIGS. 10-11. For example, the provisional credit determination system 102 communicates with the client device 114 to provide and receive information pertaining to various client transactions and communicates with the agent computing device 118 for processing disputes. Indeed, the inter-network facilitation system 104 or the provisional credit determination system 102 can generate a likelihood of approval score for determining whether to grant provisional credit to a user account.

As described in greater detail below (e.g., in relation to FIG. 10), the inter-network facilitation system 104 can manage interactions across multiple devices, providers, and computer systems. For example, the inter-network facilitation system 104 can execute transactions across various third-party systems, such as a banking entity, automated transaction machines, or payment providers. The inter-network facilitation system 104 can also maintain and manage digital accounts for client devices/users to store, manage, and/or transfer funds to other users.

In one or more embodiments, the inter-network facilitation system 104 communicates with the client device 114 in response to receiving identification information from the client device 114. In particular, the inter-network facilitation system 104 provides an indication of a secured account associated with a digital account to indicate that the client device 114 is authorized to receive information pertaining to the digital account. For example, the inter-network facilitation system 104 provides information to the client device 114, such as direct deposit status, transaction information, digital account updates, device fee information, check status, interaction history, transaction status, activation, etc.

As indicated by FIG. 1, the client device 114 includes the device application 116. In particular, the device application 116 can include a web application, a native application installed on the client devices 114 (e.g., a mobile application, a desktop application, etc.), or a cloud-based application where all or part of the functionality is performed by the server(s) 106. In some embodiments, the inter-network facilitation system 104 or the provisional credit determination system 102 communicates with the client device 114 through the device application 116. This communication, for example, includes account information and transaction information including direct deposit status, digital account updates, device fee information, check status, interaction history, transaction status, activation, etc. As shown, the provisional credit determination system 102 can provide digital account information and secured account information for display within a graphical user interface 120 associated with the device application 116.

As further shown in FIG. 1, the client device 114 implements the device application 116 in conjunction with interaction with the inter-network facilitation system 104 or the provisional credit determination system 102. For example, the inter-network facilitation system 104 or the provisional credit determination system 102 can monitor the activities of the device application 116. In particular, these activities can include events, such as time spent on device application 116, recently viewed pages on device application 116, recently viewed transaction on the device application 116, attempted dispute requests, etc.

Although FIG. 1 illustrates the environment having a particular number and arrangement of components associated with the provisional credit determination system 102, in some embodiments, the environment may include more or fewer components with varying configurations. For example, in some embodiments, the inter-network facilitation system 104 or the provisional credit determination system 102 can communicate directly with the client device 114, and/or the device application 116, bypassing the network 112. In these or other embodiments, the inter-network facilitation system 104 or the provisional credit determination system 102 can be implemented (entirely on in part) on the client device 114. Additionally, the inter-network facilitation system 104 or the provisional credit determination system 102 can include or communicate with a database for storing information, such as recent direct deposits, ATM withdrawals, debit, or credit transactions, pending transactions, digital account updates, interaction history, and/or other information described herein.

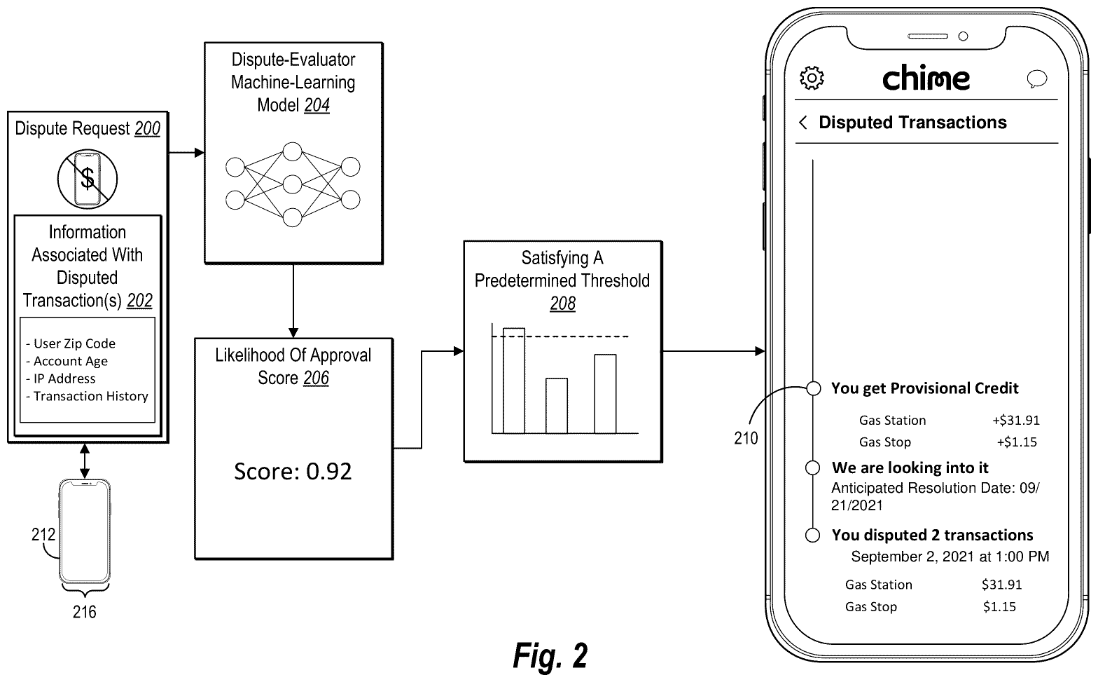

As discussed above, the provisional credit determination system 102 can generate, utilizing a dispute-evaluator machine-learning model, a likelihood of approval score. Specifically, FIG. 2 shows the provisional credit determination system 102 receiving a dispute request from client device 212 via device application 216 and utilizing a dispute-evaluator machine-learning model 204 to generate a likelihood of approval score for the disputed request to determine whether it satisfies a predetermined threshold. If the likelihood of approval score satisfies the predetermined threshold, then the provisional credit determination system 102 grants provisional credit. The following paragraphs for FIG. 2 show a high-level overview of the provisional credit determination system 102 granting provisional credit.

As a threshold determination, in some embodiments, the provisional credit determination system 102 utilizes a machine learning model to determine whether to grant provisional credit when a disputed transaction satisfies a threshold amount. For instance, in some cases, the provisional credit determination system 102 employs a machine learning model to when a disputed transaction equals or exceeds a threshold value (e.g., $25, $50, $100). If, in such embodiments, the disputed transaction does not equal or exceed such a threshold value, in certain embodiments, the provisional credit determination system 102 automatically grants a provisional credit without utilizing the dispute-evaluator machine-learning model 204 or other machine-learning model.

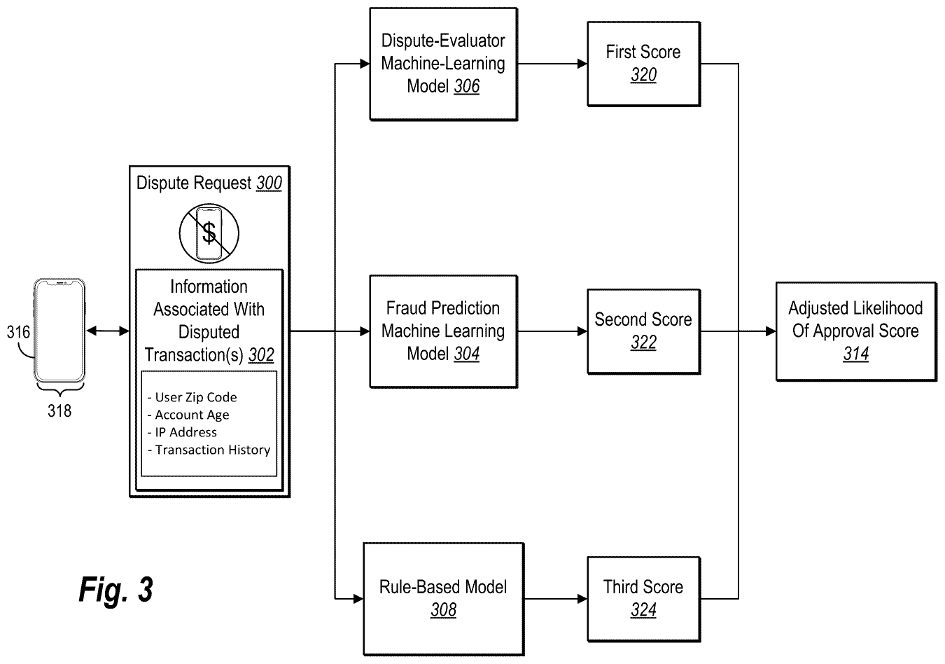

As mentioned, the provisional credit determination system 102 utilizes the information associated with the disputed transaction(s) 202 to make determinations relating to whether to grant provisional credit or not. For example, the information associated with the dispute transaction(s) 202 can include high-level metadata of a user account and transaction data. In particular, as shown in FIG. 2, the information associated with the disputed transaction(s) 202 includes a user zip code, account age, IP address of client device, and transaction history. More details of how the provisional credit determination system 102 utilizes information associated with disputed transaction(s) 202 is discussed in FIG. 3.

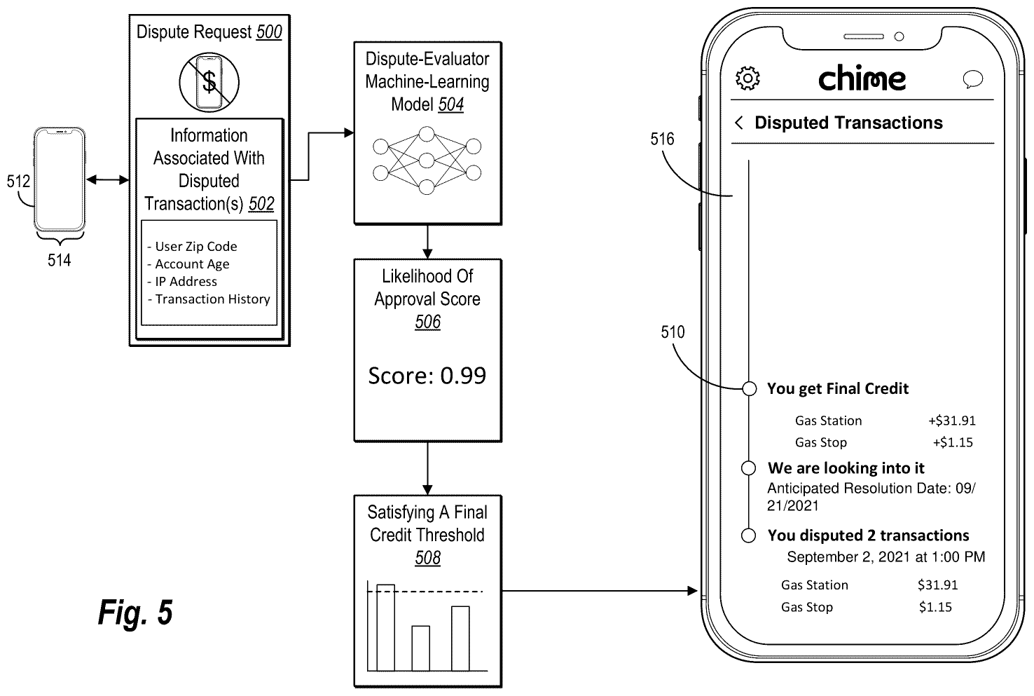

As discussed above, in some embodiments, the provisional credit determination system 102 utilizes machine learning models to intelligently determine whether to grant provisional credit. For example, a dispute-evaluator machine-learning model 204, as shown in FIG. 2, can include random forest model and XGBoost decision trees. In particular, the dispute-evaluator machine-learning model 204 can include different models, such as a fraud prediction machine learning model or a dispute-evaluator model. Additionally, the provisional credit determination system 102 can use the dispute-evaluator machine-learning model 204 in combination with other types of machine learning models or rule-based models. More details of the machine learning models, and rule-based models, are discussed in FIGS. 3, 5, 6, and 7. Details relating to the provisional credit determination system 102 generating a likelihood of approval score 206 from the dispute-evaluator machine-learning model 204 is discussed in FIGS. 3 and 5.

As further shown in FIG. 2, the dispute-evaluator machine-learning model 204 generates the likelihood of approval score 206 as 0.92. Subsequently, the provisional credit determination system 102 utilizes the score 0.92 to determine whether the score satisfies a predetermined threshold 208. For example, the predetermined threshold 208 refers to a threshold score that (if satisfied) indicates that a dispute request is likely to be approved. To illustrate, the predetermined threshold 208 can include a 0.90 score where the provisional credit determination system 102 deems all likelihood of approval scores exceeding 0.90 as satisfying the threshold. The predetermined threshold 208, as used in context with granting provisional credit, is distinct from a final credit threshold, which is further discussed in FIG. 5. The predetermined threshold is discussed in more detail in FIGS. 3, 5, and 7.

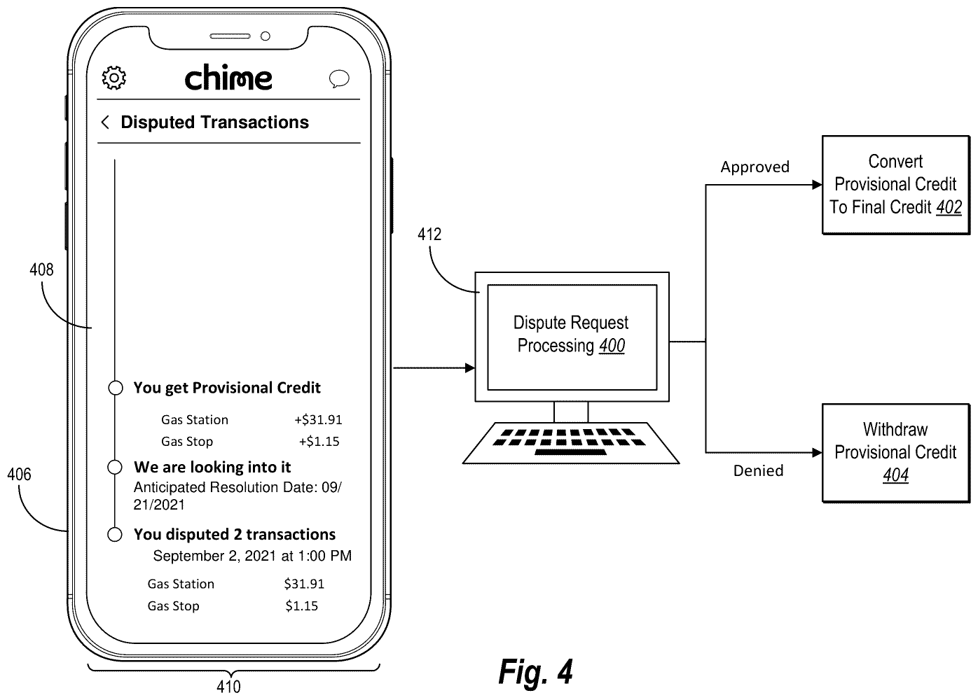

As discussed above, the provisional credit determination system 102 grants provisional credit 210 in response to the likelihood of approval score 206 satisfying the predetermined threshold 208. For example, granting provisional credit 210 results in the provisional credit determination system 102 temporarily crediting the user account associated with the dispute request 200. In particular, when the provisional credit determination system 102 determines to grant provisional credit 210, the provisional credit determination system 102 provides a user of the user account with a notification or event timeline. To illustrate, the notification or event timeline indicates that the provisional credit determination system 102 received the dispute request and granted provisional credit to the user account. Such a timeline indicating one or more resolution events is described by U.S. patent application Ser. No. 17/651,197 (filed Feb. 15, 2022), which is hereby fully incorporated herein by reference. Further details relating to granting provisional credit 210 is discussed in more detail in FIGS. 4, 6, 7, and 8A-8C.

As mentioned above, the provisional credit determination system 102 can utilize a variety of models singly or in combination with one another. Specifically, FIG. 3 shows the provisional credit determination system 102 receiving a dispute request 300 from a client device 316 via device application 318. The dispute request 300 includes information associated with disputed transaction(s) 302 and the provisional credit determination system 102 utilizes the information associated with disputed transaction(s) 302 in the following three models: (1) a fraud prediction machine learning model 304, (2) a dispute-evaluator machine learning model 306, and (3) a rule-based model 308. Each of these three models result in a generated score and an adjusted likelihood of approval score 314. The next couple of paragraphs relate to the information associated with disputed transaction(s) 302, specifically feature groups and how they are encoded within machine learning models.

As previously mentioned, the information associated with disputed transaction(s) 302 include data fields such as those shown in FIG. 3 (user zip code, account age, IP address, and transaction history). In particular, “feature groups” refers to categories of data deemed relevant by the provisional credit determination system 102 for granting provisional credit. In one or more example embodiments, relevant categories can include historical or empirically observed data. Furthermore, the feature groups received by the provisional credit determination system 102 can include broad categories of user data and/or merchant data. To illustrate, the provisional credit determination system 102 utilizes feature groups associated with disputed transaction(s) and feature groups of the user account corresponding to the dispute request to generate different scores.

In one or more example embodiments, rather than using broad categories, the provisional credit determination system uses narrow feature group categories. In particular, narrow feature group categories can include user zip code, device attribute data (historical frequencies, distance between IP addresses used at various point in time, etc.), transaction history, direct deposit history, dispute history, account age, email domain, user enrollment scores, pay friends transfers history, merchant history (historical decline rates), contact history with customer service, personal information updates, updates history, and current dispute features (amount, number of transactions, number of unique merchants, merchant categories, countries, etc.).

In one or more embodiments, the provisional credit determination system 102 utilizes historical data of a user account. In particular, the provisional credit determination system 102 can more readily determine the likelihood of a fraudulent dispute request or a low likelihood of approval when the user account associated with the dispute request 300 has a history of filing past dispute requests. To illustrate, historical data of dispute request results can include the number of previously correct provisional credits given for the user account associated with the dispute request 300, the number of provisional credits previously reversed by the provisional credit determination system 102, or an amount of a prior negative balance as a result of a reversed provisional credit. To further illustrate, if the user account associated with the dispute request 300 had previously filed three dispute requests in the last year, and two of the dispute requests were deemed fraudulent by the provisional credit determination system 102, then the provisional credit determination system 102 factors that into determining the likelihood of approval for the current dispute request 300 (i.e., whether the dispute request is fraudulent).

As just discussed, monitoring historical results of dispute requests associated with a user account can improve the rate of correctly determining whether granting provisional credit is appropriate. In one or more example embodiments, the provisional credit determination system 102 can prioritize receiving and identifying historical dispute request results in response to receiving the dispute request 300. In particular, the provisional credit determination system 102 can use intelligent incorporation of historical data when receiving the dispute request 300. To illustrate, intelligent incorporation of historical data would determine whether the provisional credit determination system 102 should receive historical dispute results based on factors such as dispute amount, or merchant associated with dispute request 300. Based on balancing different factors such as amount and merchant, the provisional credit determination system 102 can then retrieve historical data of the user account.

The next few paragraphs describe the dispute-evaluator machine learning model 306. The provisional credit determination system 102 can accomplish this by inputting the feature groups into machine learning models. For example, the dispute-evaluator machine learning model 306 can receive feature groups that drive the likelihood of approval for the dispute request 300. In some instances, feature groups that drive the likelihood of approval score includes transaction type, transaction details, account information, and/or merchant information. In particular, the provisional credit determination system 102 can utilize the dispute-evaluator machine learning model 306 to analyze the dispute request 300 and the information associated with disputed transaction(s) 302. For example, the provisional credit determination system 102 can encode information associated with the dispute request 300 and/or the information associated with disputed transaction(s) 302, e.g., feature groups (e.g., using one hot encoding, an encoding layer, or a vector mapping) and then process the encoding utilizing the dispute-evaluator machine learning model 306 to generate the likelihood of approval score (e.g., likelihood of approval score 206 as discussed in FIG. 2).

In regard to generating the likelihood of approval score, as discussed previously, in one or more embodiments, the dispute-evaluator machine-learning model 306 constitutes a decision tree, such as a random forest model, XGBoost, or a boosted gradient decision tree. Accordingly, the provisional credit determination system 102 feeds the dispute request 300 and/or the information associated with disputed transaction(s) 302 to input channels of the random forest model. The random forest model then utilizes learned nodes within one or more decision trees to generate the likelihood of approval score. In other implementations, the provisional credit determination system 102 can utilize a neural network, such as a convolutional neural network, or other machine learning model to process the dispute request 300 and/or the information associated with disputed transaction(s) 302.

As mentioned above, the provisional credit determination system 102 generates a likelihood of approval score via the dispute-evaluator machine learning model 306. For example, the provisional credit determination system 102 generates a first score 320. In particular, as discussed above, the first score 320 indicates the likelihood or probability of the dispute request being approved. The following paragraphs describe the fraud prediction machine learning model 304, the rule-based model 308, and specific example embodiments of rules that contribute to generating a score.

In addition to utilizing the dispute-evaluator machine learning model, the provisional credit determination system 102 also utilizes the fraud prediction machine learning model 304. For example, the provisional credit determination system 102 utilizes the fraud prediction machine learning model 304 to determine the probability of dispute request 300 being fraudulent. In particular, as previously mentioned, the fraud prediction machine learning model increases the integrity of the provisional credit determination system 102 by ferreting out bad actors. In some embodiments, the fraud prediction machine learning model constitutes the fraud prediction machine-learning model described by U.S. patent application Ser. No. 17/545,890 (filed Dec. 8, 2021), which is hereby incorporated by reference in its entirety.

As previously mentioned, the provisional credit determination system 102 generates scores relating to the dispute request 300. For example, as shown in FIG. 3, the fraud prediction machine learning model 304 generates a second score 322. In particular, in some cases, the second score 322 represents a metric or value indicating whether a dispute request disputing one or more network transactions is fraudulent. In some embodiments, the higher the second score 322, the higher the risk of granting provisional credit to the user account. Furthermore, a low score generated from the fraud prediction machine learning model 304 does not necessarily indicate a high probability of the dispute request 300 being approved, it merely indicates a low likelihood of fraud.

In addition to the machine learning models, the provisional credit determination system 102 can also utilize the rule-based model 308. For example, the rule-based model 308 can correlate dispute request approvals with feature groups of the disputed transactions. In particular, the provisional credit determination system 102 can establish a set of rules based on an analysis of correlation between dispute request approvals and feature groups of disputed transactions, feature groups of the user account, or feature groups of the user.

In one or more example embodiments, the provisional credit determination system 102 can use any of the feature groups discussed above and utilize models of historical dispute request data and the specific feature groups of the historical dispute request data to determine categories that correlate to certain dispute request outcomes. To illustrate, the provisional credit determination system 102 can determine that after a specific number of historical provisional credit denials for a user account, the provisional credit determination system 102 automatically denies provisional credit for all subsequent dispute requests from that user account. To further illustrate, if the user account associated with the dispute request 300 previously disputed five transactions and the provisional credit determination system 102 rejected all 5 transactions, then the provisional credit determination system 102 automatically denies granting provisional credit (e.g., provisional credit 210 as discussed in FIG. 2).

As another example of a rule established by the rule-based model 308, the provisional credit determination system 102 can establish rules based on specified merchants and transaction amounts. In particular, the provisional credit determination system 102 can determine that if the merchant is a jewelry shop and the amount of the disputed transaction exceeds $1000, then the provisional credit determination system 102 automatically denies granting provisional credit.

Moreover, the rule-based model 308 can utilize different relationships between the feature groups. For example, the rule-based model 308 can use additional derived features, such as ratios between feature group observations, and differences/interactions computed using the aforementioned feature groups. In particular, these ratios can include the relationship between a dispute amount to the average monthly direct deposit in the user account. To illustrate, if the user account averages monthly deposits of $10,000 and the user disputes $500, then the provisional credit determination system 102 can decide that this particular dispute is low risk.

As further illustrated in FIG. 3, the rule-based model 308 can generate a third score 324 indicating whether the provisional credit determination system 102 should grant provisional credit. For example, if the rule-based model 308 generates 0.50 as the third score 324, then this could indicate the satisfaction of 50% of the rules flagged by the provisional credit determination system 102. In particular, the provisional credit determination system 102 may establish the following rules for determining whether to favorably generate a score: (1) if the user account associated with the dispute request has a history of past dispute requests and the provisional credit determination system 102 approved all the past dispute requests, then generate a favorable score (e.g., 0.25 as a sub score for approved past dispute requests); (2) if the provisional credit determination system 102 has identified the merchant associated with the dispute request as pre-approved for dispute requests, then generate a favorable score (e.g., 0.25 as a sub score for pre-approved merchant); (3) if the amount of the dispute request satisfies a predetermined amount, then generate a favorable score (e.g., 0.25 as a sub score for satisfying predetermined amount); (4) if the provisional credit determination system 102 has identified the user account age associated with the dispute request as surpassing 2 years, then generate a favorable score (e.g., 0.25 as a sub score for account age). In one or more implementations, where the third score 324 is 0.50, indicates that the provisional credit determination system 102 identifies rule (1) and (2) as satisfied.

In another example embodiment, the aforementioned rules established by the provisional credit determination system 102 could each have different weights. In particular, example rule (1) could comprise 75% of the total score. Accordingly, if the provisional credit determination system 102 identifies example rules (2), (3), and (4) as satisfied but example rule (1) as not satisfied, then the highest score generated from the rule-based model is 0.25.

In one or more example embodiments, the provisional credit determination system 102 can establish priority rules. In particular, if the provisional credit determination system 102 deems the priority rules as satisfied, then the provisional credit determination system 102 automatically grants provisional credit. To illustrate, priority rules can include a rule that the user account disputes a transaction below $100 (or another value), and the user account has had five successful dispute requests. In response to this rule being satisfied, the provisional credit determination system 102 would automatically grant provisional credit despite other rules not being satisfied. To further illustrate, another priority rule could include the provisional credit determination system 102 determining the transaction of the dispute request 300 as unauthorized, namely, unauthorized as a result of a stolen card. In response to this determination, the provisional credit determination system 102 can immediately issue provisional credit to the user account associated with the dispute request 300.

In one or more example embodiments, the provisional credit determination system 102 can establish red flag rules. In particular, for the red flag rules, if the provisional credit determination system 102 deems a red flag rule as satisfied, the provisional credit determination system 102 automatically denies provisional credit. To illustrate, a red flag rule could include the user account associated with the dispute request 300 identified as a first party fraudster based on a user account having a pattern of filing dispute request as a bad actor, such as the user account filing 2 fraudulent dispute requests. First party fraudster as used in this context refers to the immediate user that filed the dispute request 300 as attempting to defraud the provisional credit determination system 102.

In other example embodiments, rules established by the provisional credit determination system 102 that strongly influence whether the provisional credit determination system 102 grants provisional credit can also include a rule that determines the likelihood of successfully obtaining the chargeback paid by the merchant. In particular, if the likelihood is high, then the provisional credit determination system 102 can automatically issue provisional credit. Furthermore, another rule established by the rule-based model 308 can determine whether an item associated with the dispute request 300 was successfully returned but the merchant failed to issue a refund. If this is the case, the provisional credit determination system 102 can automatically issue provisional credit.

As further illustrated in FIG. 3, the provisional credit determination system 102 can generate an adjusted likelihood of approval score 314. For example, the provisional credit determination system 102 can generate the adjusted likelihood of approval score 314 based on a combination of scores. In particular, the provisional credit determination system 102 can use a combination of the first score 320 with the second score 322 and/or the third score 324. To illustrate, the provisional credit determination system 102 uses a combination of different models, such as the machine learning models and rule-based model 308 to generate the adjusted likelihood of approval score 314. Moreover, the provisional credit determination system 102 can generate the adjusted likelihood of approval score 314 by averaging the scores, by intelligently balancing the scores (e.g., a weighted average of the scores), or by selectively excluding one of the scores.

As just noted, in one or more example embodiments, the provisional credit determination system 102 can intelligently balance the first score 320, the second score 322 and the third score 324. In particular, the provisional credit determination system 102 utilizes all three models (dispute-evaluator machine learning model 306, fraud prediction machine learning model 304, and rule-based model 308) and weighs the importance of each model based on predetermined factors. In particular, weighing the importance of each model based on predetermined factors could include intelligent weighting based on merchant, amount, user account details, etc.

To illustrate intelligently balancing the scores, in some embodiments, if the provisional credit determination system 102 generates the second score 322 (from the fraud prediction machine learning model 304) with a high probability of a fraudulent transaction, then the provisional credit determination system 102 can adjust the first score 320 (from the dispute-evaluator machine learning model 306) by reducing it by 0.20 (or a different amount predetermined by the provisional credit determination system 102). Conversely, if the provisional credit determination system 102 identifies the probability of a fraudulent transaction as low, then the provisional credit determination system 102 can adjust the first score by increasing it by 0.05.

In other example embodiments, as mentioned above, the provisional credit determination system selectively excludes a score. To illustrate, the adjusted likelihood of approval score 314 can just include the second score 322 and the third score 324 (fraud prediction machine learning model 304 and rule-based model 308) or the adjusted likelihood of approval score 314 can just include the first score 320 and third score 324.

Further examples of how the scores generated from the different models influence the adjusted likelihood of approval score 314 include the provisional credit determination system 102 establishing ranges for certain scores. To illustrate, as similarly discussed above, if the provisional credit determination system 102 establishes a range of 0.50-0.70 for the second score 322 (fraud prediction machine learning model 304), and if the second score 322 falls within this range, then the provisional credit determination system 102 can adjust the likelihood of approval score by reducing the likelihood of approval by 0.20. Moreover, if the third score 324 generated from the rule-based model falls below a pre-established “low range,” then the provisional credit determination system 102 reduces the adjusted likelihood of approval score 314. While if the third score 324 falls within a pre-established “middle range,” then the provisional credit determination system 102 does not alter the adjusted likelihood of approval score 314. Moreover, if the third score 324 falls within a “high range” then the provisional credit determination system 102 can increase the adjusted likelihood of approval score 314.

Although FIG. 3 illustrates the use of multiple models to generate the adjusted likelihood of approval score 314, the provisional credit determination system 102 can generate adjusted likelihood of approval score 314 in a variety of ways. For example, instead of using the models in combination, the provisional credit determination system 102 can decide to merely use the rule-based model 308 for solely determining whether to grant provisional credit. Alternatively, the provisional credit determination system 102 could solely rely on the fraud prediction machine learning model 304 for determining whether to grant provisional credit.

Furthermore, in some embodiments, the provisional credit determination system 102 can continually update the adjusted likelihood of approval score 314. For example, the provisional credit determination system 102 can run previous dispute requests pending approval, and if the provisional credit determination system 102 identifies updates to the user account associated with the dispute request 300, the provisional credit determination system 102 can alter the adjusted likelihood of approval score 314. In particular, the provisional credit determination system 102 could perform this action every 4 hours. Further, the provisional credit determination system 102 can also run all the dispute requests in batch to update other adjusted likelihood of approval scores associated with dispute requests.

As discussed above, the provisional credit determination system 102 can grant provisional credit in response to the likelihood of approval score satisfying the predetermined threshold (e.g., predetermined threshold 208 as discussed in FIG. 2). For instance, FIG. 4 illustrates either approving the dispute request or denying the dispute request. Specifically, FIG. 4 shows a graphical user interface 408 where the provisional credit determination system 102 granted provisional credit to client device 406 (associated with a user) via a device application 410. After the provisional credit determination system 102 grants provisional credit, the provisional credit determination system 102 performs an act 400 of dispute request processing. The following paragraphs discuss specific acts of processing performed by the agent computing devices.

As just mentioned, the act 400 of processing a dispute request involves a variety of procedures. In one or more example embodiments, an agent computing device 412 after receiving the dispute request, can identify whether the provisional credit determination system 102 granted provisional credit for the received dispute request. In particular, the agent computing device 412 can receive an exact likelihood of approval score from the provisional credit determination system 102. To illustrate, the provisional credit determination system 102 can indicate to the agent computing device 412 that the provisional credit determination system 102 generated a likelihood of approval score of 0.92.

In one or more example embodiments, the agent computing device 412 can also utilize the previously discussed models in FIG. 3. In particular, the agent computing device 412 can identify the different scores generated from the machine learning models (e.g., dispute-evaluator machine learning model 306 or fraud prediction machine learning model 304 as discussed in FIG. 3) or rule-based models (e.g., rule-based model 308 as discussed in FIG. 3), the feature groups utilized by the models, and/or use the models with different feature groups to generate adjusted likelihood of approval scores (e.g., adjusted likelihood of approval score 314 as discussed in FIG. 3). Accordingly, the agent computing device 412 can utilize the models to assist in deciding the validity of the dispute request (in addition to contacting merchants associated with the dispute request transactions, contacting the user who filed the dispute request, or hiring third-party investigators). To illustrate utilizing the models to decide, the agent computing device 412 can send an API request to the provisional credit determination system 102 to convert the generated scores from the models into a decision of whether or not to approve the dispute request.

In one or more example embodiments, the provisional credit determination system 102 can place a heavy emphasis on processing decisions made by the agent computing devices. Moreover, decisions made by the agent computing device 412 provide a feedback loop for the models discussed in FIG. 3. In some embodiments, the agent computing device 412 determines one or more scores for a dispute request (based upon which) labels are created and attached to each dispute request. In particular, the provisional credit determination system 102 labels all denied dispute requests negatively. To illustrate, the provisional credit determination system 102 can assign negative labels to all dispute requests where the agent computing device 412 closed a user account for attempting or actually defrauding the provisional credit determination system 102. In this instance, the provisional credit determination system 102 assigns negative labels irrespective of individual dispute request outcomes. This data aids the provisional credit determination system 102 in identifying a pattern of serial offenders.

In one or more example embodiments, the provisional credit determination system 102 stores all data and scores utilized by the machine learning models and rule-based models. In particular, the agent computing device 412 can access all data and scores stored by the provisional credit determination system 102. To illustrate, the agent computing device 412 can access data and scores used by the provisional credit determination system 102 between a couple of minutes to a couple of hours from utilization/generation by the provisional credit determination system 102.

As discussed above, the provisional credit determination system 102 can perform the act 402 of converting provisional credit to final credit. For example, once the agent computing device 412 has taken appropriate measures (contacted all of the necessary entities and followed policies predetermined by the provisional credit determination system 102) then the agent computing device 412 can instruct the provisional credit determination system 102 to perform the act 402 of converting provisional credit to final credit. In particular, after converting the provisional credit to final credit, the provisional credit determination system 102 can send a notification to the client device 406 corresponding to the dispute request.

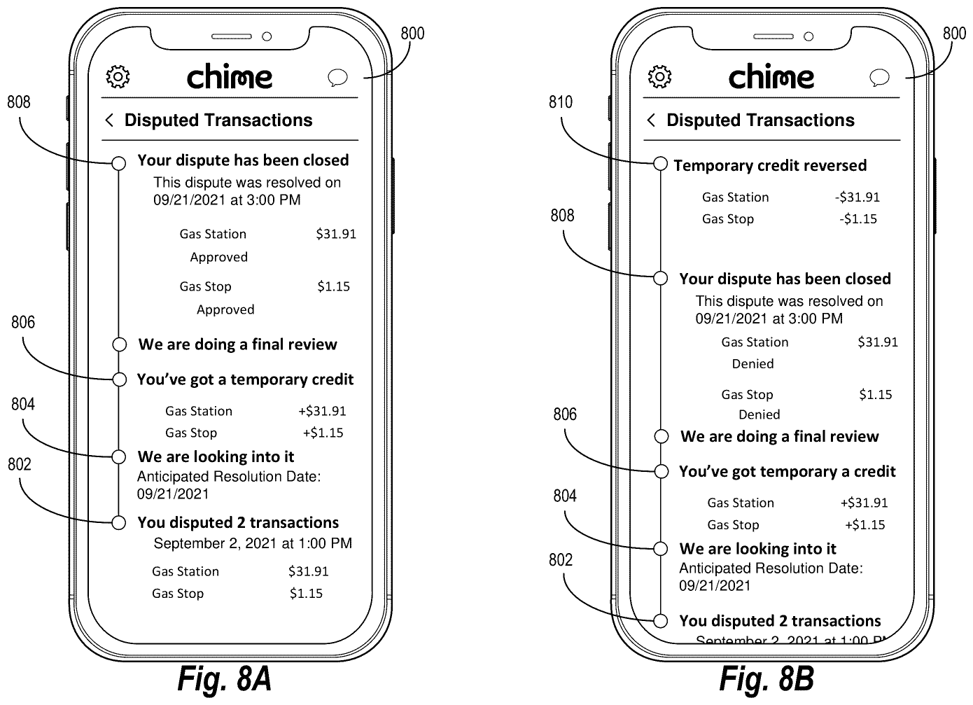

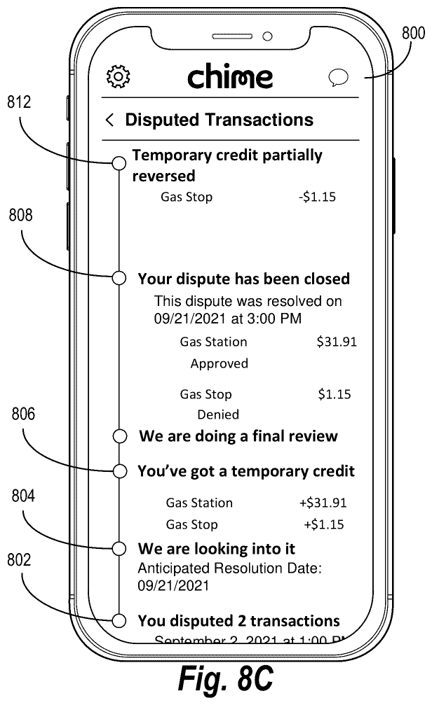

In one or more example embodiments, the agent computing device 412 can base an approval decision more heavily on available dispute request history. In particular, when the provisional credit determination system 102 performs act 402, the user account associated with the dispute request receives a notification. The notification can include information pertaining to the dispute request process and an indication of the provisional credit converting to final credit. The provisional credit determination system 102 can automatically update the user account ledger. The graphical user interface of the act 402 is discussed in FIGS. 8A-8C.

As also discussed, the provisional credit determination system 102 can also perform the act 404 of withdrawing provisional credit. Similar to the act 402, the act 404 can include a notification to the user account associated with the dispute request. In particular, the provisional credit determination system 102 automatically updates the user account ledger to withdraw the previously granted provisional credit and flags the result for future utilization by the models discussed in FIG. 3.

In one or more example embodiments, the provisional credit determination system 102 can perform the act 404 in response to a canceled dispute request. In particular, if the user account associated with the dispute request cancels the dispute request prior to a determination of the dispute request status, the provisional credit determination system 102 performs the act 404. Moreover, in response to a canceled dispute request, the provisional credit determination system 102 can flag it for future utilization by the models discussed in FIG. 3.

As discussed above, the provisional credit determination system 102 can convert provisional credit into final credit. FIG. 5 illustrates the provisional credit determination system 102 granting final credit 510 instead of provisional credit. Specifically, FIG. 5 illustrates the provisional credit determination system 102 receiving a dispute request 500 from a client device 512 via a device application 514. The dispute request 500 includes information associated with disputed transaction(s) 502 and a dispute-evaluator machine-learning model 504 utilizes the information associated with disputed transaction(s) 502. The dispute-evaluator machine-learning model 504 generates a likelihood of approval score 506 and grants final credit 510 if the likelihood of approval score 506 satisfies a final credit threshold 508. The aforementioned elements besides the final credit threshold 508 are substantially similar to the discussion in FIGS. 2 and 3.

The final credit threshold 508 is similar to the discussion relating to the predetermined threshold (e.g., predetermined threshold 208 as discussed in FIG. 2). In one or more example embodiments, the provisional credit determination system 102 preestablishes the final credit threshold 508 based on what it considers a significant probability that it will approve the dispute request 500. In particular, in some embodiments, the provisional credit determination system 102 designates the final credit threshold 508 as higher than the predetermined threshold (for provisional credit). To illustrate, if the provisional credit threshold is 0.70, the final credit threshold 508 is greater than 0.70. As illustrated by FIG. 5, the provisional credit determination system 102 generates the likelihood of approval score 506 as 0.99.

In one or more example embodiments, the provisional credit determination system 102 can automatically grant final credit 510 rather than determining whether to grant provisional credit. As mentioned, for this to happen, the provisional credit determination system 102 only makes this determination if the likelihood of approval score 506 satisfies a higher threshold than the predetermined threshold set for provisional credit. In particular, the automatic granting of final credit 510 improves the efficiency of the system by conserving resources used to investigate dispute request 500 and reduces the utilization of computational resources.

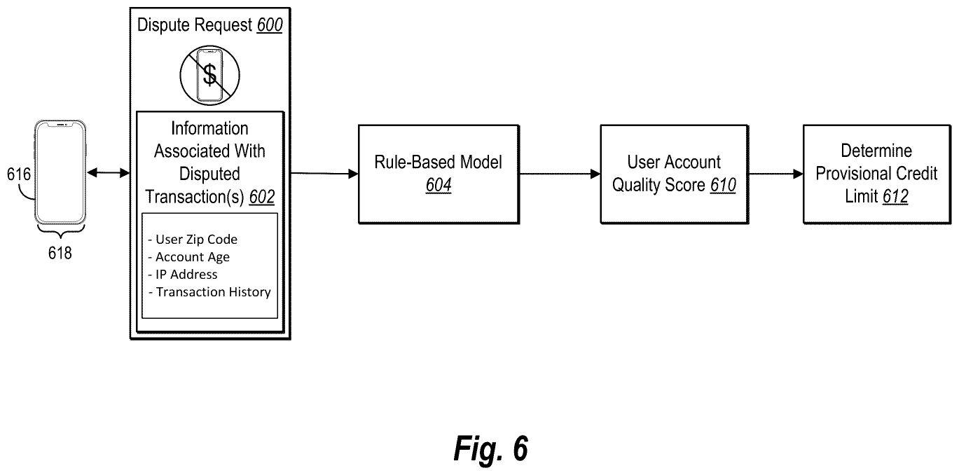

In one or more example embodiments, the provisional credit determination system 102 can automatically grant final credit 510 if the user account associated with the dispute request 500 has certain qualities or attributes (e.g., account age, dispute request history, etc.). To illustrate, for final credit, this may include the provisional credit determination system 102 establishing that if the dispute amount for the dispute request 500 is below $10 and the provisional credit determination system 102 has approved all prior dispute requests from that user account, then the provisional credit determination system 102 can automatically grant final credit 510. A similar process is discussed in more detail in FIG. 6.

As shown in FIG. 5, the provisional credit determination system 102 can display the final credit 510 granted to the user via a graphical user interface 516. In particular, the graphical user interface 516 indicates that the provisional credit determination system 102 received the dispute request and granted final credit 510. Furthermore, similar to other embodiments, in response to granting final credit 510, the provisional credit determination system 102 can send a notification to the user account associated with the dispute request 500.

Although FIG. 5 illustrates granting final credit when the likelihood of approval score 506 satisfies the final credit threshold 508, granting final credit can also occur in different ways. The provisional credit determination system 102 can preestablish de minimis write-off thresholds. In one or more example embodiments, this includes automatically writing off dispute amounts below $100 (the provisional credit determination system 102 grants final credit automatically). In particular, the provisional credit determination system 102 determines de minimis write-off thresholds based on factors, such as risk of the particular dispute, the merchant, user account details, history of dispute requests, or machine learning principles. To illustrate, the provisional credit determination system 102 can adjust the de minimis threshold based on scores generated from the aforementioned models. Alternatively, the provisional credit determination system 102 can determine to not have a de minimis write-off threshold.

Additionally or alternatively, in some embodiments, the provisional credit determination system 102 preestablishes a minimum likelihood of approval score (or final denial threshold) that, when a dispute request's likelihood of approval score equals or falls below, results in automatic denial of the dispute request. In particular, in some embodiments, the provisional credit determination system 102 designates the minimum likelihood of approval score (or final denial threshold) as lower than the predetermined threshold for provisional credit. To illustrate, in some embodiments, the provisional credit determination system 102 automatically denies a dispute request when a likelihood of approval score equals or is below 0.05, 0.10, or some other minimum likelihood of approval score.

As previously mentioned, the provisional credit determination system 102 can determine a provisional credit limit 612. FIG. 6 illustrates the provisional credit determination system 102 using a rule-based model 604 to determine the provisional credit limit 612. Specifically, FIG. 6 shows the provisional credit determination system 102 receiving a dispute request 600 from a client device 616 via a device application 618. The dispute request 600 includes information associated with disputed transaction(s) 602 and utilizes that information in the rule-based model 604. Based on the rule-based model 604 generating a user account quality score 610, the provisional credit determination system 102 can determine the provisional credit limit 612.

As used herein, the term “user account quality score” refers to a score that incorporates user account history. In particular, the user account quality score can include the user account's Loan-to-Value (LTV) ratio or the behavioral quality of a user account. To illustrate, the LTV ratio can identify the amount of provisional credit potentially granted and the value of the user's account. Additionally, the behavioral quality of a user account can include the provisional credit determination system 102 determining the amount deposited every month by the user account, the age of the user account, the number of on time payments vs. late payments, the frequency of disputes, or any combination of these and other factors. The provisional credit determination system 102 designates both the LTV and behavioral quality of a user account scores as user account quality scores.

As used herein, the term “provisional credit limit” refers to the maximum amount of provisional credit allowed for a user account associated with a dispute request. In particular, a provisional credit limit can fluctuate based on determinations, such as scores generated from models of the provisional credit determination system 102 or updates to historical data for prior dispute requests of the user account. To illustrate, the provisional credit determination system 102 can determine that the provisional credit limit 612 for a user account is $250.00.

In certain example embodiments, the provisional credit determination system 102 uses different ranges to determine the provisional credit limit based on the user account quality score 610. In particular, the provisional credit determination system 102 can designate “top percentiles,” “average percentiles,” and “low percentiles” for user account quality scores. To illustrate, the provisional credit determination system 102 can have “top percentiles” include all user account quality scores above 0.90. In addition, the provisional credit determination system 102 can have “average percentiles” as all user account quality scores between 0.65-0.90 and “low percentiles” as all user account quality scores below 0.65. To further illustrate, in some instances, user account quality score 610 in the top percentile can have the provisional credit limit 612 at under $3500. While average percentile user account quality scores can have the provisional credit limit 612 at under $1000. Whereas low percentile user account quality scores can have the provisional credit limit 612 at under $100.

While FIG. 6 illustrates determining provisional credit limit 612 based on the user account quality score 610, the provisional credit determination system 102 can utilize the user account quality score 610 for other purposes. In one or more example embodiments, the provisional credit determination system 102 can determine to only issue provisional credit to preestablished percentile groups. To illustrate, in some embodiments, the provisional credit determination system 102 only grants provisional credit to middle percentile and top percentile user account quality scores. By contrast, in other example embodiments, the percentile does not matter for granting provisional credit.

Further, as discussed previously in FIG. 5, in one or more example embodiments, the provisional credit determination system 102 can also determine based on user account quality score 610 whether to grant a final credit. In particular, the decision whether to grant final credit can apply the same principles discussed in this section relating to user account quality scores and different percentiles. To reiterate, the provisional credit determination system 102 can determine to grant final credit only to users that fall within the top percentile for user account quality scores, or it can elevate the de minims write-off threshold based on user account quality scores.

Moreover, in one or more example embodiments, the provisional credit determination system 102 can utilize the provisional credit limit 612 to grant partial provisional credit. In particular, if the dispute request 600 has a dispute amount of $500 but the provisional credit determination system 102 determines the provisional credit limit 612 as $250, then the provisional credit determination system 102 only grants up to $250 to the user account associated with the dispute request 600.

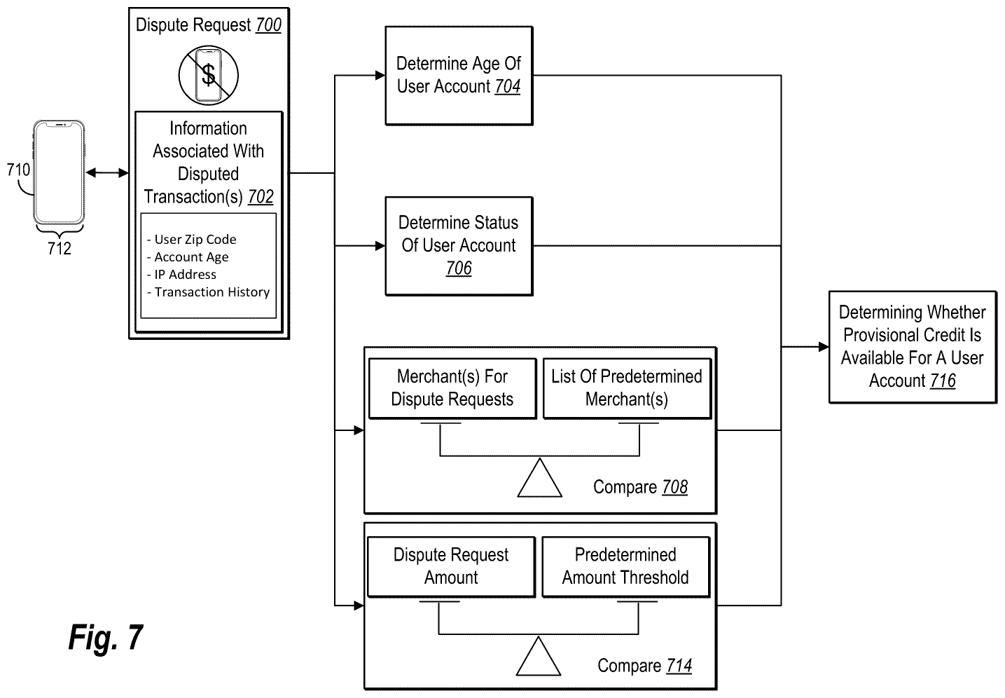

As discussed previously, the provisional credit determination system 102 can determine whether provisional credit is available. As illustrated, FIG. 7 shows the provisional credit determination system 102 receiving a dispute request 700 with information associated with disputed transaction(s) 702 from a client device 710 via a device application 712. The provisional credit determination system 102 then determines different factors to perform an act of determining whether provisional credit is available.

As shown in FIG. 7, one of the factors determined by the provisional credit determination system 102 includes an act 704 of determining the age of the user account. For example, the provisional credit determination system 102 upon receiving the dispute request 700 can identify the age of the user account from the information associated with disputed transaction 702. In particular, the provisional credit determination system 102 can preestablish that an account age under 1 month negatively influences the availability of provisional credit. In other words, the provisional credit determination system 102 makes an account age determination to filter out new accounts from receiving provisional credit. To illustrate, by determining the age of the user account, the provisional credit determination system 102 potentially reduces fraud in the provisional credit determination system 102.

Another factor determined by the provisional credit determination system 102 can include an act 706 of determining status of user account. For example, the provisional credit determination system 102 identifies metadata corresponding to the user account status. In particular, the provisional credit determination system 102 identifies user accounts with a dormant status. Dormant status can include no transaction activity (prior to the dispute request) for greater than 6 months. To illustrate, this filters out infrequent users of the provisional credit determination system 102 and reduces the potential for fraud in the provisional credit determination system 102.

An additional factor determined by the provisional credit determination system 102 can include comparing data associated with the dispute request 700. For example, comparing includes an act 708 of comparing a merchant associated with the dispute request 700 to a list of predetermined merchant(s). In particular, the provisional credit determination system 102 identifies the merchant(s) associated with the dispute request 700 from the information associated with the disputed transaction(s) 702 and determines whether the identified merchant(s) match any one of the merchants on the list of predetermined merchants. To illustrate, the provisional credit determination system 102 may have a predetermined list of merchants based on past dispute history where the merchant has a low likelihood of refunding money, a merchant that has no feasible method of contact, or a merchant with a policy of no refunds. Furthermore, if any of the merchant(s) identified match the predetermined list of merchants, then this may negatively influence whether provisional credit is available. This increases the efficiency of the provisional credit determination system 102 because dispute requests that have a merchant unlikely to grant a refund would occupy the provisional credit determination system's 102 computational resources.

Moreover, another factor determined by the provisional credit determination system 102 can include an act 714 of comparing dispute request amount with a predetermined amount threshold. In particular, the provisional credit determination system 102 can have a predetermined transaction amount that the provisional credit determination system 102 designates as likely ineligible for provisional credit. To illustrate, the provisional credit determination system 102 could designate all transactions over $5000 as likely ineligible for provisional credit. If the dispute request 700 includes multiple transactions, the provisional credit determination system 102 can compare each of the multiple transactions with the predetermined amount threshold or the transactions in aggregate. Transactions with dispute amounts exceeding the predetermined amount threshold can cause the provisional credit determination system 102 to negatively influence whether provisional credit is available. In some example embodiments with multiple transactions part of the dispute request 700, where some transactions exceed the predetermined amount threshold and others do not, the provisional credit determination system 102 can exclude just the transactions that exceed the predetermined amount threshold from provisional credit.

The act 716 of determining whether provisional credit is available includes the provisional credit determination system 102 incorporating the aforementioned factors and weighing whether provisional credit should be available for the user account associated with dispute request 700. For example, the provisional credit determination system 102 can establish that each of the aforementioned factors have a weight of 0.25 out of 1.0 and the provisional credit determination system 102 requires a weight of at least 0.50 for making provisional credit available. In incorporating the examples given above, if the dispute request 700 has an account age of 1 year and the dispute request amount does not exceed the predetermined amount threshold, then provisional credit is available for the user account because it meets the requirement of 0.50 (0.25×2).

In other example embodiments, the provisional credit determination system 102 can weight the aforementioned factors unevenly. To illustrate, the provisional credit determination system 102 can establish the act 708 of merchant comparison as having a weight of 0.50 and the act 714 of comparing dispute amount as having a weight of 0.40 whereas user account status and age of user account each have weights of 0.05. In other instances, the provisional credit determination system 102 can establish one of the aforementioned factors as mandatory for making provisional credit available while the remaining factors each have a weight of 0.33.

As suggested above, in some embodiments, the provisional credit determination system 102 automatically denies a dispute request when certain features of the dispute request fail to satisfy one or more threshold criteria. For instance, in some embodiments, the provisional credit determination system 102 automatically denies a dispute request based one or more of the following: (i) a likelihood of approval score equals or is below a minimum likelihood of approval score, (ii) a user account associated with the dispute request has submitted a threshold number of dispute requests (e.g., 5 or 10 dispute requests within a threshold period of time), (iii) a user account quality score associated with the dispute request equals or falls below a minimum user account quality score, or (iv) an age of a disputed transaction equals or exceeds a threshold age (e.g., 6 months, 1 year).

In one or more example embodiments, after performing the act 716, the provisional credit determination system 102 utilizes the other models discussed above. In particular, if the provisional credit determination system 102 determines the availability of provisional credit, then the provisional credit determination system 102 continues with utilizing models to determine the likelihood of approval score as previously discussed in FIGS. 2, 3, and 5. Additionally, in response to the provisional credit determination system 102 determining the unavailability of provisional credit, the provisional credit determination system 102 can send a notification to the user account indicating the unavailability of provisional credit and updating the user account regarding the status of the dispute request.

As previously discussed, the provisional credit determination system 102 can display via a graphical user interface the granting of provisional credit. As illustrated, FIGS. 8A-8C show a computing device presenting a graphical user interface 800 of different dispute request outcomes. FIG. 8A shows a timeline with multiple resolution events. For example, FIG. 8A shows the provisional credit determination system 102 receiving dispute request 804 with dispute request details 802. Additionally, an indication of provisional credit 806 and a final result of the dispute request 808 is shown. In particular, FIG. 8A illustrates a dispute request where the provisional credit determination system 102 approves both transactions in the dispute request. Accordingly, the final result of the dispute request 808 shows the provisional credit converting into final credit.

FIG. 8B mirrors FIG. 8A except the provisional credit determination system 102 denies both of the transactions of the dispute request. In particular, as indicated in FIG. 8B, the provisional credit determination system 102 performs an act 810 of reversing the provisional credit in response to the denial of both transactions in the dispute request. Furthermore, in one or more instances, the provisional credit determination system 102 can provide an option for the user account corresponding to the dispute request to contact the provisional credit determination system 102 for further details regarding the denial.

FIG. 8C mirrors both FIGS. 8A and 8B except the provisional credit determination system 102 denies one of the transactions and approves one of the transactions of the dispute request. As indicated in FIG. 8C, the provisional credit determination system 102 performs an act 812 of partially reversing the provisional credit. Likewise, the provisional credit determination system 102 can provide an option for the user account corresponding to the dispute request to contact the provisional credit determination system 102 for further details regarding the denial.

In one or more example embodiments, the provisional credit determination system 102 does not process dispute requests or grant provisional credit for pending transactions. In some instances, however, the dispute requests may allow the user to file a dispute request for pending transactions, but the provisional credit determination system 102 waits until the pending transaction is settled before moving forward with processing or granting provisional credit. Although not shown in FIGS. 8A-8C, the provisional credit determination system 102 would indicate on the graphical user interface 800 of the timeline that the provisional credit determination system 102 has received the dispute request but is awaiting settlement of the pending transaction.

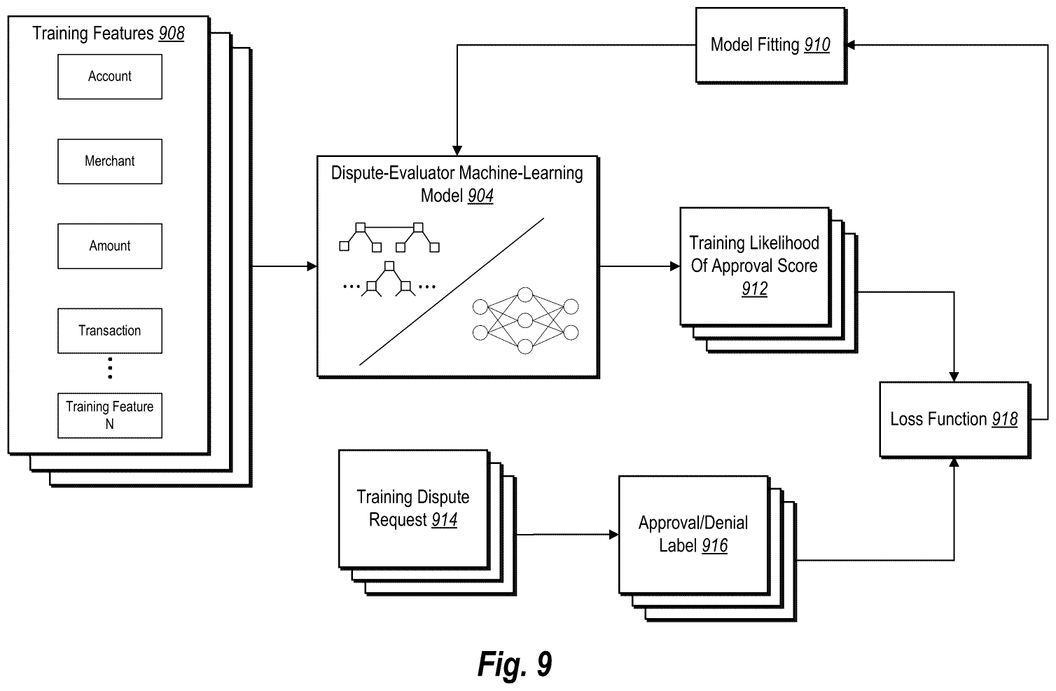

As mentioned above, in certain embodiments, the provisional credit determination system 102 trains or tunes a dispute-evaluator machine-learning model 904 (e.g., the dispute-evaluator machine-learning model 204, 306, and 504). In particular, provisional credit determination system 102 utilizes an iterative training process to fit a dispute-evaluator machine-learning model by adjusting or adding decision trees or learning parameters that result in accurate likelihood of approval predictions (e.g., likelihood of approval score). FIG. 9 illustrates training a dispute-evaluator machine-learning model in accordance with one or more embodiments.

As illustrated in FIG. 9, the provisional credit determination system 102 accesses a training dispute request 914. The training dispute request 914 constitutes a dispute request disputing one or more network transactions and is used to train the dispute-evaluator machine-learning model 904. The training dispute request 914 has a corresponding approval/denial label 916, where the approval/denial label 916 indicates whether the training dispute request 914 was previously determined to be either approved or not approved. For example, the training dispute request 914 could be a dispute request previously submitted that a team of researchers determined or confirmed as either approved or not approved. Accordingly, in some cases, the provisional credit determination system 102 treats the approval/denial label 916 as a ground truth for training the dispute-evaluator machine-learning model 904.

As further illustrated in FIG. 9, the provisional credit determination system 102 provides training features 908 associated with the training dispute request 914 to the dispute-evaluator machine-learning model 904 and utilizes the dispute-evaluator machine-learning model 904 to generate a training likelihood of approval score 912 based on the training features 908. As the name indicates, the training features 908 represent features associated with a training dispute request 914 that are used for training the dispute-evaluator machine-learning model 904. Accordingly, the training features 908 can constitute a feature from any of the feature groups or an individual features described herein. In some embodiments, the dispute-evaluator machine-learning model 904 generates a set of training likelihood of approval predictions, including a predicted likelihood of approval classification with a corresponding probability that the training dispute request 914 will be approved. The training likelihood of approval score 912 can accordingly take the form of any of the likelihood of approval scores described above.

As further illustrated in FIG. 9, the provisional credit determination system 102 utilizes a loss function to compare the training likelihood of approval score 912 and the approval/denial label 916 (e.g., to determine an error or a measure of loss between them). For instance, in cases where the dispute-evaluator machine-learning model 904 is an ensemble of gradient boosted trees, the provisional credit determination system 102 utilizes a mean squared error loss function (e.g., for regression) and/or a logarithmic loss function (e.g., for classification) as the loss function 918.

By contrast, in embodiments where the dispute-evaluator machine-learning model 904 is a neural network, the provisional credit determination system 102 can utilize a cross-entropy loss function, an L1 loss function, or a mean squared error loss function as the loss function 918. For example, the provisional credit determination system 102 utilizes the loss function 918 to determine a difference between the training likelihood of approval score 912 and the approval/denial label 916.

As further illustrated in FIG. 9, the provisional credit determination system 102 performs model fitting 910. In particular, the provisional credit determination system 102 fits the dispute-evaluator machine-learning model 904 based on loss from the loss function 918. For instance, the provisional credit determination system 102 performs modifications or adjustments to the dispute-evaluator machine-learning model 904 to reduce the measure of loss from the loss function 918 for a subsequent training iteration.

For gradient boosted trees, for example, the provisional credit determination system 102 trains the dispute-evaluator machine-learning model 904 on the gradients of errors determined by the loss function 918. For instance, the provisional credit determination system 102 solves a convex optimization problem (e.g., of infinite dimensions) while regularizing the objective to avoid overfitting. In certain implementations, the provisional credit determination system 102 scales the gradients to emphasize corrections to under-represented classes (e.g., high likelihood of approval classifications or low likelihood of approval classifications).

In some embodiments, the provisional credit determination system 102 adds a new weak learner (e.g., a new boosted tree) to the dispute-evaluator machine-learning model 904 for each successive training iteration as part of solving the optimization problem. For example, the provisional credit determination system 102 finds a feature that minimizes a loss from the loss function 918 and either adds the feature to the current iteration's tree or starts to build a new tree with the feature

In addition, or in the alternative, to gradient boosted decision trees, the provisional credit determination system 102 trains a logistic regression to learn parameters for generating one or more likelihood of approval scores. To avoid overfitting, the provisional credit determination system 102 further regularizes based on hyperparameters, such as the learning rate, stochastic gradient boosting, the number of trees, the tree-depth(s), complexity penalization, and L1/L2 regularization

In some embodiments where the dispute-evaluator machine-learning model 904 is a neural network, the provisional credit determination system 102 performs the model fitting 910 by modifying internal parameters (e.g., weights) of the dispute-evaluator machine-learning model 904 to reduce the measure of loss for the loss function 918. Indeed, the provisional credit determination system 102 modifies how the dispute-evaluator machine-learning model 904 analyzes and passes data between layers and neurons by modifying the internal network parameters. Thus, over multiple iterations, the provisional credit determination system 102 improves the accuracy of the dispute-evaluator machine-learning model 904.

Indeed, in some cases, the provisional credit determination system 102 repeats the training process illustrated in FIG. 9 for multiple iterations. For example, the provisional credit determination system 102 repeats the iterative training by selecting a new set of training features for each training dispute request along with a corresponding approval/denial label. The provisional credit determination system 102 further generates a new set of training likelihood of approval scores for each iteration. As described above, the provisional credit determination system 102 also compares a training likelihood of approval score at each iteration with the corresponding training approval/denial label and further performs model fitting 910. The provisional credit determination system 102 repeats this process until the dispute-evaluator machine-learning model 904 generates training likelihood of approval scores that result in likelihood of approval scores that satisfy a threshold measure of loss.

As discussed above, the provisional credit determination system 102 can use an XGBoost machine learning model as the dispute-evaluator machine-learning model. In one or more example embodiments, the provisional credit determination system 102 determines an optimal number of trees to use in the dispute-evaluator machine-learning model. In particular, the optimal number of trees includes the provisional credit determination system 102 determining top feature groups and interactions between feature groups to utilize for generating the likelihood of approval score. To illustrate, this includes the provisional credit determination system 102 utilizing 700 trees with 50 rounds and using mean average precision as a primary metric for determining sufficiency. Moreover, an XGBoost model dump parser allows for ranking feature groups as well as feature interactions of various depth by different metrics (gain, F-score, average gain, average F-score, expected gain). The aforementioned machine learning principles discussed above aid the dispute-evaluator machine learning model in providing real-time scores and determining whether or not to grant provisional credit.

As mentioned above, in some embodiments, the provisional credit determination system 102 identifies features associated with a dispute request. In particular, the provisional credit determination system 102 determines how impactful individual features are in determining a likelihood of approval score. FIG. 10 illustrates an example visualization of various features associated with a dispute request in accordance with one or more embodiments.

As illustrated in FIG. 10, the provisional credit determination system 102 determines the relative importance of features. For example, the provisional credit determination system 102 determines feature importance by running cross-validation on the dataset. Specifically, the provisional credit determination system 102 determines feature importance by running cross-validation across ten random cross-validation splits, and as shown in FIG. 10, determines a gain for each feature, where the bar graph for each feature (roughly) indicates its importance. By evaluating the feature importance multiple times across the random splits, the result is a more reliable estimate of feature importance. Indeed, using a gradient boosted decision tree (or other decision tree) in this manner enables the provisional credit determination system 102 to identify and narrow down more important features to make for a more efficient machine-learning model that uses less memory and computer processing than other models.

As further shown in FIG. 10, the provisional credit determination system 102 can rank the features according to importance as well. For instance, the provisional credit determination system 102 determines that a dispute amount (e.g., the dispute_unique_merchant_name_count_disputed_amount_interaction) is highest among those displayed within the feature importance interface 1002, followed by the ratio of dispute amount to average amount of transaction (e.g., the dispute_unique_merchant_name_count_count_ratio_of_dispute_amt_to_avg_amount_transacted_interaction), an average transaction amount to the average transaction count (e.g., dispute_avg_trans_amt_dispute_transaction_count_interaction), and so forth down the list.

In one or more embodiments, the dispute-evaluator machine learning model encodes the feature groups using target encoding to compute a target mean for each feature group. To illustrate, the feature groups using target encoding to compute a target mean is shown below by the following pseudocode in table 1:

TABLE 1
#Compute target mean by group /*posterior” mean averages*/ =
temp.groupby(by=trn_series.name)[target.name].agg([“mean”, “count”])
#Compute smoothing weight = 1 / (1 + np.exp(−(averages[“count”] − min_samples) /
smoothing))
#Apply average function to sample target data /*this is our “prior” mean prior*/ = target.mean( )
#The bigger the count the less full_avg is taken into account averages[target.name] = prior * (1
− weight) + averages[“mean”] * weight

In particular, as indicated by the pseudocode in table 1, the target mean in this context refers to a weighted sum of the sample target average. Further, the posterior mean in table 1 represents a conditional probability, which is for example, the probability of a second feature group event occurring given that a first feature group event has occurred. Additionally, in relation to the weighted sum of the sample target average shown in table 1, the weight refers to the number of observations for a feature group. Moreover, the provisional credit determination system 102 utilizes the number of observations of a feature group (the weight) and represents it as a sigmoid function. Within the sigmoid function, the provisional credit determination system 102 utilizes two additional parameters (1) min_sampling and (2) smoothing.

In one or more example embodiments, min_sampling refers to an inflection point, where if the feature group count is above the min_sampling parameter, the weight attached to the specific feature group becomes greater than 0.5 and vice versa. Smoothing controls the rate of transition between target mean and posterior mean (e.g., how fast the group specific weight increases with the group size). The dispute-evaluator machine learning model utilizes a plurality of feature groups and can designate a different weight for each of the plurality of feature groups used by the dispute-evaluator machine learning model. In some instances, after computing the weighted sum of the sample target average, random noise is added to prevent overfitting (e.g., when a model matches its training data). Adding random noise to the weighted target average is shown in the pseudocode below of table 2:

TABLE 2
def add_noise(series, noise_level):
return series * (1 + noise_level * np.random.randn(len(series)))
averages[target.name] = add_noise(averages[target.name], noise_level)

As suggested, by determining importance of features, in some embodiments, the provisional credit determination system 102 can provide a reason for rejecting (or approving) a dispute request. For instance, in response to a request from the agent computing device 118, the provisional credit determination system 102 can provide to the agent computing device 118 with a reason for a dispute-evaluator machine-learning model determining a likelihood of approval score indicates likelihood of rejection (or approval) based on an importance-of-features analysis. To illustrate, the provisional credit determination system 102 may identify particular features corresponding to one or more disputed transactions that explain a rejection of a provisional credit, such as name of a black-listed merchant, a disputed amount, a number of dispute request, or some other feature or combination of features from a feature-importance graph depicted in FIG. 10.

As just mentioned, the provisional credit determination system 102 uses feature groups via the dispute-evaluator machine learning model to determine whether to grant provisional credit to a user account associated with the dispute request. As mentioned above, the provisional credit determination system 102 improves in accuracy of detecting dispute requests with a high likelihood of approval over prior network-transaction-security systems. In particular, the provisional credit determination system 102 reduces false-positive likelihood of approval scores and false-negative likelihood of approval scores compared to prior network-transaction-security systems. FIG. 11A illustrates a graph depicting improvements in true positive and false positive rates for the provisional credit determination system 102 determining likelihood of approval scores for dispute requests utilizing a dispute-evaluator machine learning model in accordance with one or more embodiments. The graphs and data depicted in FIG. 11A are based on a validation dataset of dispute requests analyzed by the dispute-evaluator machine learning model.

As illustrated in FIG. 11A, a graph 1102 includes a receiver operating characteristic (ROC) curve that illustrates reductions in likelihood of approval score false positives for the provisional credit determination system 102 as compared to without recalibrating via training likelihood of approval scores by a dispute-evaluator machine-learning model. In particular, the graph 1102 depicts an ROC curve 1104 that depicts a true positive rate over a false positive rate with an area under the curve of 0.912. For the ROC curve 1104, the true positive rate represents true-positive-likelihood of approval dispute requests identified by the dispute-evaluator machine-learning model divided by the sum of true-positive-likelihood of approval dispute requests and false-positive-likelihood of approval dispute requests identified by the dispute-evaluator machine-learning model. By contrast, the false positive rate represents false-positive-likelihood of approval dispute requests identified by the dispute-evaluator machine-learning model divided by the sum of true-positive-likelihood of approval dispute requests and false-positive-likelihood of approval dispute requests identified by the dispute-evaluator machine-learning model.

The provisional credit determination system 102 also improves in accurately identifying likelihood of approval scores over other systems. FIG. 11A illustrates a graph depicting the accuracy of the dispute-evaluator machine learning model in accordance with one or more embodiments.

As illustrated in FIG. 11A, a graph 1106 includes a binary precision-recall curve that depicts precision over recall. In the graph 1102, precision represents the number of true-positive-likelihood of approval dispute requests divided by the sum of true-positive-likelihood of approval dispute requests and false-positive-likelihood of approval dispute requests. By contrast, recall represents the number of true-positive-likelihood of approval dispute requests divided by the sum of true-positive-likelihood of approval dispute requests and false-negative-likelihood of approval dispute requests. As shown, the provisional credit determination system 102 utilizing the dispute-evaluator machine-learning model provides for an average precision of 0.879.

As depicted in FIG. 11A, the provisional credit determination system 102 accurately identifies a large number of likelihood of approval dispute requests at a low recall. For example, at an average of about ninety percent precision, recall is approximately twenty-five percent. Thus, for all submitted disputes, the provisional credit determination system 102 accurately identifies approximately one quarter of all disputes as true-positive-likelihood of approval dispute requests. Indeed, by accurately identifying a high number of true-positive-likelihood of approval dispute requests, the provisional credit determination system 102 can take remedial actions (e.g., suspending a transaction or account) on low likelihood of approval dispute requests.

As just mentioned, the provisional credit determination system 102 improves in accuracy of detecting dispute requests with a high likelihood of approval over prior network-transaction-security systems. In particular, the provisional credit determination system 102 reduces false-positive likelihood of approval scores and false-negative likelihood of approval scores compared to prior network-transaction-security systems. FIG. 11B illustrates additional graphs depicting improvements in true positive and false positive rates for the provisional credit determination system 102 determining likelihood of approval scores for dispute requests utilizing a dispute-evaluator machine learning model in accordance with one or more embodiments. The graphs and data depicted in FIG. 11B are based on a test dataset of dispute requests analyzed by the dispute-evaluator machine learning model.

As illustrated in FIG. 11B, a graph 1108 includes a receiver operating characteristic (ROC) curve that illustrates reductions in likelihood of approval score false positives for the provisional credit determination system 102 as compared to without recalibrating via training likelihood of approval scores by a dispute-evaluator machine-learning model. In particular, the graph 1108 depicts an ROC curve 1110 that depicts a true positive rate over a false positive rate with an area under the curve of 0.914. For the ROC curve 1110, the true positive rate represents true-positive-likelihood of approval dispute requests identified by the dispute-evaluator machine-learning model divided by the sum of true-positive-likelihood of approval dispute requests and false-positive-likelihood of approval dispute requests identified by the dispute-evaluator machine-learning model. By contrast, the false positive rate represents false-positive-likelihood of approval dispute requests identified by the dispute-evaluator machine-learning model divided by the sum of true-positive-likelihood of approval dispute requests and false-positive-likelihood of approval dispute requests identified by the dispute-evaluator machine-learning model.

The provisional credit determination system 102 also improves in accurately identifying likelihood of approval scores over other systems. FIG. 11B illustrates a graph depicting the accuracy of the dispute-evaluator machine learning model in accordance with one or more embodiments.

As illustrated in FIG. 11B, a graph 1112 includes a binary precision-recall curve that depicts precision over recall. In the graph 1108, precision represents the number of true-positive-likelihood of approval dispute requests divided by the sum of true-positive-likelihood of approval dispute requests and false-positive-likelihood of approval dispute requests. By contrast, recall represents the number of true-positive-likelihood of approval dispute requests divided by the sum of true-positive-likelihood of approval dispute requests and false-negative-likelihood of approval dispute requests. As shown, the provisional credit determination system 102 utilizing the dispute-evaluator machine-learning model provides for an average precision of 0.904.

As depicted in FIG. 11B, the provisional credit determination system 102 accurately identifies a large number of likelihood of approval dispute requests at a low recall. For example, at an average of about ninety percent precision, recall is approximately twenty-five percent. Thus, for all submitted disputes, the provisional credit determination system 102 accurately identifies approximately one quarter of all disputes as true-positive-likelihood of approval dispute requests. Indeed, by accurately identifying a high number of true-positive-likelihood of approval dispute requests, the provisional credit determination system 102 can take remedial actions (e.g., suspending a transaction or account) on low likelihood of approval dispute requests.

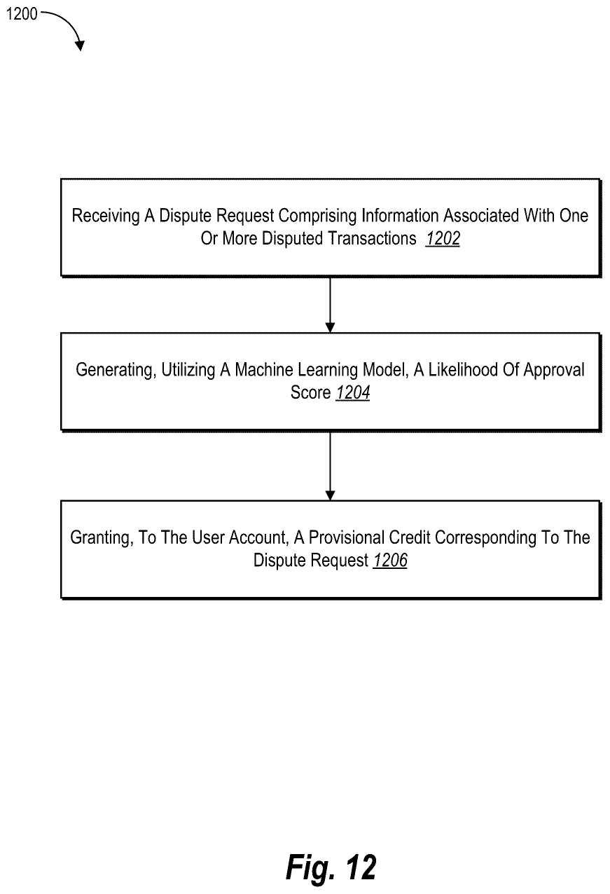

FIGS. 1-11B, the corresponding text, and the examples provide a number of different systems, methods, and non-transitory computer readable media for selecting and providing a transportation request to a limited-eligibility provider device. In addition to the foregoing, embodiments can also be described in terms of flowcharts comprising acts for accomplishing a particular result. For example, FIG. 12 illustrates a flowchart of an example sequence of acts in accordance with one or more embodiments.

FIG. 12 illustrates an example series of acts 1200 for generating a likelihood of approval score via the provisional credit determination system 102. The series of acts 1200 can include an act 1202 of receiving a dispute request comprising information associated with one or more disputed transactions. For example, this includes receiving, from a client device, a dispute request comprising information associated with one or more disputed transactions within a user account corresponding to the client device.

As shown, the series of acts 1200 can also include an act 1204 of generating, utilizing a dispute-evaluator machine-learning model, a likelihood of approval score. For example, the act 1204 includes generating, utilizing a dispute-evaluator machine-learning model, a likelihood of approval score based at least in part on the information associated with the one or more disputed transactions. Further, the act 1204 can include wherein generating, utilizing the dispute-evaluator machine-learning model, the likelihood of approval score further comprises utilizing at least one of a rule-based model or a fraud-prediction machine learning model in combination with the dispute-evaluator machine-learning model. In particular, the act 1204 can also include generating a user account quality score and determining a provisional credit limit, based on the user account quality score. Additionally, the act 1204 includes wherein generating, utilizing the dispute-evaluator machine-learning model, the likelihood of approval score further comprises incorporating historical disputed transaction data of the user account. Moreover, the act 1204 includes wherein generating the likelihood of approval score further comprises utilizing a plurality of feature groups in the dispute-evaluator machine-learning model; and assigning a weight to each of the plurality of feature groups.

As shown, the series of acts 1200 can also include an act 1206 of granting, to the user account, a provisional credit corresponding to the dispute request. For example, the act 1206 also includes based on the likelihood of approval score satisfying a predetermined threshold, granting, to the user account, a provisional credit corresponding to the dispute request. Further, the act 1206 can include processing the dispute request, if the dispute request is approved, converting the provisional credit into final credit, or if the dispute request is denied, withdrawing the provisional credit. The act 1206 also includes granting, to the user account, a provisional credit occurs in real time or near-real time of receiving the dispute request.

Additionally, the act 1206 includes wherein granting the provisional credit is further based on at least one of: determining an age of the user account, determining a dormant status of the user account, comparing a merchant of the dispute request to a list of predetermined merchants, or comparing an amount of the dispute request to a predetermined amount threshold. Moreover, the act 1206 further comprises granting final credit when an output of at least one of the dispute-evaluator machine-learning model, rule-based model or the fraud-prediction machine learning model satisfies a final credit threshold.

While FIG. 12 illustrates acts according to some embodiments, alternative embodiments may omit, add to, reorder, and/or modify any of the acts shown in FIG. 12. The acts of FIG. 9 can be performed as part of a method. Alternatively, a non-transitory computer readable medium can comprise instructions, that when executed by one or more processors, cause a computing device to perform the acts of FIG. 12. In still further embodiments, a system can perform the acts of FIG. 12. Additionally, the acts described herein may be repeated or performed in parallel with one another or in parallel with different instances of the same or other similar acts.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

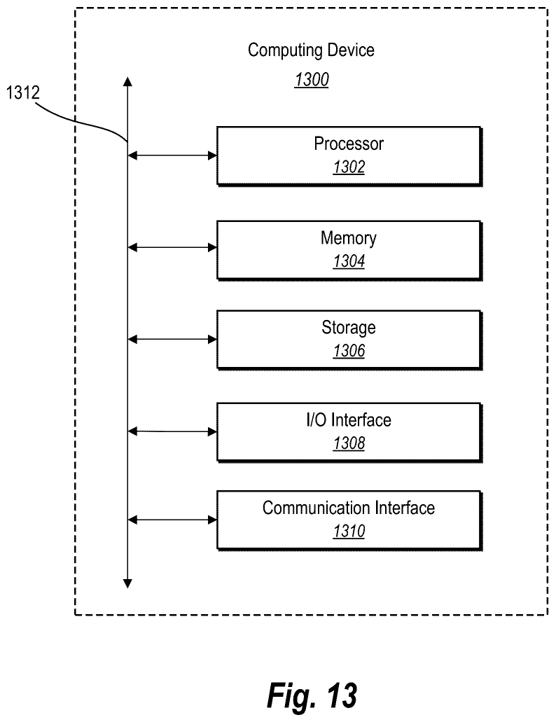

FIG. 13 illustrates, in block diagram form, an exemplary computing device 1300 (e.g., the client device 114, or the server(s) 106) that may be configured to perform one or more of the processes described above. As shown by FIG. 13, the computing device can comprise a processor 1302, memory 1304, a storage device 1306, an I/O interface 1308 interface 1308, and a communication interface 1310. In certain embodiments, the computing device 1300 can include fewer or more components than those shown in FIG. 13. Components of computing device 1300 shown in FIG. 9 will now be described in additional detail.

In particular embodiments, processor(s) 1302 includes hardware for executing instructions, such as those making up a computer program. As an example, and not by way of limitation, to execute instructions, processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, storage device 1306 can comprise a non-transitory storage medium described above. The storage device 1306 may include a hard disk drive (“HDD”), flash memory, a Universal Serial Bus (“USB”) drive or a combination of these or other storage devices.

The computing device 1300 also includes one or more input or output interface 1308 interface 1308 (or “I/O interface 1308”), which are provided to allow a user (e.g., requester or provider) to provide input to (such as user strokes), receive output from, and otherwise transfer data to and from the computing device 1300. These I/O interface 1308 may include a mouse, keypad or a keyboard, a touch screen, camera, optical scanner, network interface, modem, other known I/O devices or a combination of such I/O interface 1308. The touch screen may be activated with a stylus or a finger.

The I/O interface 1308 may include one or more devices for presenting output to a user, including, but not limited to, a graphics engine, a display (e.g., a display screen), one or more output providers (e.g., display providers), one or more audio speakers, and one or more audio providers. In certain embodiments, interface 1308 is configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 can provide one or more interfaces for communication (such as, for example, packet-based communication) between the computing device and one or more other computing devices 1300 or one or more networks. As an example, and not by way of limitation, communication interface 1310 may include a network interface controller (“NIC”) or network adapter for communicating with an Ethernet or other wire-based network or a wireless NIC (“WNIC”) or wireless adapter for communicating with a wireless network, such as a WI-FI. The computing device 1300 can further include a bus 1312. The bus 1312 can comprise hardware, software, or both that connects components of computing device 1300 to each other.

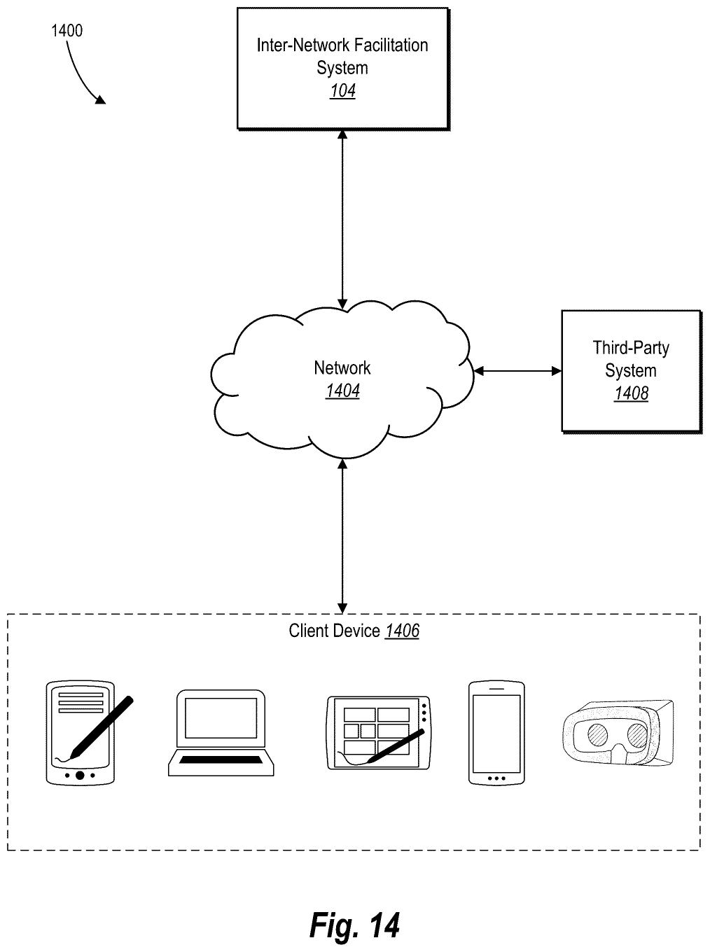

FIG. 14 illustrates an example network environment 1400 of the inter-network facilitation system 104. The network environment 1400 includes a client device 1406 (e.g., client device 114), an inter-network facilitation system 104, and a third-party system 1408 connected to each other by a network 1404. Although FIG. 14 illustrates a particular arrangement of the client device 1406, the inter-network facilitation system 104, the third-party system 1408, and the network 1404, this disclosure contemplates any suitable arrangement of client device 1406, the inter-network facilitation system 104, the third-party system 1408, and the network 1404. As an example, and not by way of limitation, two or more of client device 1406, the inter-network facilitation system 104, and the third-party system 1408 communicate directly, bypassing network 1404. As another example, two or more of client device 1406, the inter-network facilitation system 104, and the third-party system 1408 may be physically or logically co-located with each other in whole or in part.

Moreover, although FIG. 14 illustrates a particular number of client devices 1406, inter-network facilitation systems 104, third-party systems 1408, and networks 1404, this disclosure contemplates any suitable number of client devices 1406, inter-network facilitation system 104, third-party systems 1408, and networks 1404. As an example, and not by way of limitation, network environment 1400 may include multiple client device 1406, inter-network facilitation system 104, third-party systems 1408, and/or networks 1404.

This disclosure contemplates any suitable network 1404. As an example, and not by way of limitation, one or more portions of network 1404 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1404 may include one or more networks 1404.

Links may connect client device 1406 and third-party system 1408 to network 1404 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1400. One or more first links may differ in one or more respects from one or more second links.

In particular embodiments, the client device 1406 may be an electronic device including hardware, software, or embedded logic components or a combination of two or more such components and capable of carrying out the appropriate functionalities implemented or supported by client device 1406. As an example, and not by way of limitation, a client device 1406 may include any of the computing devices discussed above in relation to FIG. 14. A client device 1406 may enable a network user at the client device 1406 to access network 1404. A client device 1406 may enable its user to communicate with other users at other client devices 1406.

In particular embodiments, the client device 1406 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1406 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1406 one or more Hyper Text Markup Language (“HTML”) files responsive to the HTTP request. The client device 1406 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1404) to link the third-party-system 1408. For example, the inter-network facilitation system 104 may receive authentication credentials from a user to link a third-party system 1408 such as an online bank account, credit account, debit account, or other financial account to a user account within the inter-network facilitation system 104. The inter-network facilitation system 104 can subsequently communicate with the third-party system 1408 to detect or identify balances, transactions, withdrawal, transfers, deposits, credits, debits, or other transaction types associated with the third-party system 1408. The inter-network facilitation system 104 can further provide the aforementioned or other financial information associated with the third-party system 1408 for display via the client device 1406. In some cases, the inter-network facilitation system 104 links more than one third-party system 1408, receiving account information for accounts associated with each respective third-party system 1408 and performing operations or transactions between the different systems via authorized network connections.

In particular embodiments, the inter-network facilitation system 104 may interface between an online banking system and a credit processing system via the network 1404. For example, the inter-network facilitation system 104 can provide access to a bank account of a third-party system 1408 and linked to a user account within the inter-network facilitation system 104. Indeed, the inter-network facilitation system 104 can facilitate access to, and transactions to and from, the bank account of the third-party system 1408 via a client application of the inter-network facilitation system 104 on the client device 1406. The inter-network facilitation system 104 can also communicate with a credit processing system, an ATM system, and/or other financial systems (e.g., via the network 1404) to authorize and process credit charges to a credit account, perform ATM transactions, perform transfers (or other transactions) across accounts of different third-party systems 1408, and to present corresponding information via the client device 1406.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1408), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1400 either directly or via network 1404. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1406, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1404.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1406. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1406. Information may be pushed to a client device 1406 as notifications, or information may be pulled from client device 1406 responsive to a request received from client device 1406. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1406 associated with users.

In addition, the third-party system 1408 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1404. A third-party system 1408 can communicate with the inter-network facilitation system 104 to provide financial information pertaining to balances, transactions, and other information, whereupon the inter-network facilitation system 104 can provide corresponding information for display via the client device 1406. In particular embodiments, a third-party system 1408 communicates with the inter-network facilitation system 104 to update account balances, transaction histories, credit usage, and other internal information of the inter-network facilitation system 104 and/or the third-party system 1408 based on user interaction with the inter-network facilitation system 104 (e.g., via the client device 1406). Indeed, the inter-network facilitation system 104 can synchronize information across one or more third-party systems 1408 to reflect accurate account information (e.g., balances, transactions, etc.) across one or more networked systems, including instances where a transaction (e.g., a transfer) from one third-party system 1408 affects another third-party system 1408.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a dispute request comprising information associated with one or more disputed transactions within a user account corresponding to the client device;
generating, utilizing a dispute-evaluator machine-learning model, a likelihood of approval score based at least in part on the information associated with the one or more disputed transactions; and
based on the likelihood of approval score satisfying a predetermined threshold, granting, to the user account, a provisional credit corresponding to the dispute request.

2. The computer-implemented method of claim 1, further comprises:
processing the dispute request;
if the dispute request is approved, converting the provisional credit into final credit; or
if the dispute request is denied, withdrawing the provisional credit.

3. The computer-implemented method of claim 1, wherein generating, utilizing the dispute-evaluator machine-learning model, the likelihood of approval score further comprises utilizing at least one of a rule-based model or a fraud-prediction machine learning model in combination with the dispute-evaluator machine-learning model.

4. The computer-implemented method of claim 3, further comprises granting final credit when an output of at least one of the dispute-evaluator machine-learning model, rule-based model, or the fraud-prediction machine learning model satisfies a final credit threshold.

5. The computer-implemented method of claim 1, wherein granting, to the user account, a provisional credit occurs in real time or near-real time of receiving the dispute request.

6. The computer-implemented method of claim 1 further comprising:
generating a user account quality score; and
determining a provisional credit limit, based on the user account quality score.

7. The computer-implemented method of claim 1, wherein generating, utilizing the dispute-evaluator machine-learning model, the likelihood of approval score further comprises incorporating historical disputed transaction data of the user account.

8. The computer-implemented method of claim 1, wherein generating the likelihood of approval score further comprises:
utilizing a plurality of feature groups in the dispute-evaluator machine-learning model; and
assigning a weight to each of the plurality of feature groups.

9. The computer-implemented method of claim 1, wherein granting the provisional credit is further based on at least one of:
determining an age of the user account;
determining a dormant status of the user account;
comparing a merchant of the dispute request to a list of predetermined merchants; or
comparing an amount of the dispute request to a predetermined amount threshold.

10. A non-transitory computer-readable medium storing instructions that, when executed by at least one processor, cause a computer system to:
receive, from a client device, a dispute request comprising information associated with one or more disputed transactions within a user account corresponding to the client device;
generate, utilizing a dispute-evaluator machine-learning model, a likelihood of approval score based at least in part on the information associated with the one or more disputed transactions; and
based on the likelihood of approval score satisfying a predetermined threshold, grant, to the user account, a provisional credit corresponding to the dispute request.

11. A non-transitory computer-readable medium of claim 10, wherein generating, utilizing the dispute-evaluator machine-learning model, the likelihood of approval score further comprises utilizing at least one of a rule-based model or a fraud-prediction machine learning model in combination with the dispute-evaluator machine-learning model.

12. A non-transitory computer-readable medium of claim 10, wherein granting, to the user account, a provisional credit occurs in real time or near-real time of receiving the dispute request.

13. A non-transitory computer-readable medium of claim 10, further comprises:
generating a user account quality score; and
determining a provisional credit limit, based on the user account quality score.

14. A non-transitory computer-readable medium of claim 10, wherein generating, utilizing the dispute-evaluator machine-learning model the likelihood of approval score further comprises incorporating historical data of the user account to adjust the likelihood of approval score.

15. A non-transitory computer-readable medium of claim 10, wherein granting the provisional credit is further based on at least one of:
determining an age of the user account;
determining a dormant status of the user account;
comparing a merchant of the dispute request to a list of predetermined merchants; or
comparing an amount of the dispute request to a predetermined amount threshold.

16. A system comprising:
at least one processor; and
at least one non-transitory computer-readable storage medium storing instructions that, when executed by the at least one processor, cause the system to:
receive, from a client device, a dispute request comprising information associated with one or more disputed transactions within a user account corresponding to the client device;
generate, utilizing a dispute-evaluator machine-learning model, a likelihood of approval score based at least in part on the information associated with the one or more disputed transactions; and
based on the likelihood of approval score satisfying a predetermined threshold, grant, to the user account, a provisional credit corresponding to the dispute request.

17. The system of claim 16, wherein generating, utilizing the dispute-evaluator machine-learning model, the likelihood of approval score further comprising instructions that, when executed by the at least one processor, cause the system to utilize at least one of a rule-based model or a fraud-prediction machine learning model in combination with the dispute-evaluator machine-learning model.

18. The system of claim 16, wherein generating, utilizing the dispute-evaluator machine-learning model further comprising instructions that, when executed by the at least one processor, cause the system to:
generate a user account quality score; and
determine a provisional credit limit, based on the user account quality score.

19. The system of claim 16, wherein generating, utilizing the dispute-evaluator machine-learning model the likelihood of approval score comprising instructions that, when executed by the at least one processor, cause the system to incorporate historical data of the user account to adjust the likelihood of approval score.

20. The system of claim 16, wherein granting, to the user account, a provisional credit comprising instructions that, when executed by the at least one processor, cause the system to:
determine an age of the user account;
determine a dormant status of the user account;
compare a merchant of the dispute request to a list of predetermined merchants; or
compare an amount of the dispute request to a predetermined amount threshold.
